(19) United States
(12) Patent Application Publication
(10) Pub. No.: US 2018/0038309 A1
(43) Pub. Date: Feb. 8, 2018

(54) PISTON OF INTERNAL COMBUSTION ENGINE OR METHOD FOR PROCESSING SURFACE OF PISTON OF INTERNAL COMBUSTION ENGINE

(71) Applicant: HITACHI AUTOMOTIVE SYSTEMS, LTD., Hitachinaka-shi, Ibaraki (JP)

(72) Inventor: Masato SASAKI, Sagamihara-shi, Kanagawa (JP)

(73) Assignee: HITACHI AUTOMOTIVE SYSTEMS, LTD., Hitachinaka-shi, Ibaraki (JP)

(21) Appl. No.: 15/552,826

(22) PCT Filed: Mar. 7, 2016
(86) PCT No.: PCT/JP2016/056914

§ 371 Date: Aug. 23, 2017

(30) Foreign Application Priority Data
Mar. 23, 2015 (JP) 2015-059906

(51) Int. Cl. F02F 3/10; F16J 1/08; F16J 1/01

(52) U.S. Cl. CPC F02F 3/10; F16J 1/01; F16J 1/08; F02F 2200/00

(57) ABSTRACT

Provided is a piston of an internal combustion engine that can reduce a fluid lubrication frictional coefficient on an outer peripheral surface of a skirt portion. The piston of the internal combustion engine includes at least one electrodeposited film on the outer peripheral surface of the skirt portion that is slidably moved relative to an inner wall of a cylinder.

### TECHNICAL FIELD

The present invention relates to a piston of an internal combustion engine or a method for processing a surface thereof.

### BACKGROUND ART

There is known a piston of an internal combustion engine that includes a film on an outer peripheral surface of a skirt portion slidably movable relative to an inner wall of a cylinder (for example, PTL 1).

### CITATION LIST

### Patent Literature

PTL 1: Japanese Patent Application Public Disclosure No. 2010-216362

### SUMMARY OF INVENTION

### Technical Problem

Conventionally, no consideration is given to a frictional coefficient under fluid lubrication of the outer peripheral surface of the skirt portion.

### Solution to Problem

According to one aspect of the present invention, a piston preferably includes at least one electrodeposited film layer on an outer peripheral surface of a skirt portion.

Therefore, the fluid lubrication frictional coefficient on the outer peripheral surface of the skirt portion can be reduced.

### BRIEF DESCRIPTION OF DRAWINGS

FIG. 1 illustrate a side and a cross-section of a piston according to an embodiment.

FIG. 2 illustrates cross-sections of a cylinder and the piston according to the embodiment.

FIG. 3 schematically illustrates a cross-section of a skirt portion outer peripheral surface according to a first embodiment.

FIG. 4 illustrates an electrodeposition coating apparatus (a first example) according to the embodiment.

FIG. 5 illustrates how electrodeposition coating is carried out by the electrodeposition coating apparatus according to the first example.

FIG. 6 illustrates an electrodeposition coating apparatus (a second example) according to the embodiment.

FIG. 7 illustrates a liquid passage member of the electrodeposition coating apparatus according to the second example.

FIG. 8 illustrates experiment data indicating a relationship between a height of a streak and a fluid lubrication friction coefficient on the skirt portion outer peripheral surface.

FIG. 9 schematically illustrates a cross-section of the skirt portion outer peripheral surface in a case where one film layer is formed without use of the electrodeposition coating.

FIG. 10 schematically illustrates a cross-section of a skirt portion outer peripheral surface according to a second embodiment.

FIG. 11 schematically illustrates a cross-section of the skirt portion outer peripheral surface in a case where two film layers are formed without use of the electrodeposition coating.

FIG. 12 schematically illustrates a cross-section of a skirt portion outer peripheral surface according to a third embodiment.

FIG. 13 illustrates a cross-section of the skirt portion outer peripheral surface in a result of an experiment according to the third embodiment.

FIG. 14 schematically illustrates a cross-section of a skirt portion outer peripheral surface according to a fourth embodiment.

FIG. 15 schematically illustrates a cross-section of a skirt portion outer peripheral surface according to a fifth embodiment.

FIG. 16 illustrates a cross-section of the skirt portion outer peripheral surface in a result of an experiment according to the fifth embodiment.

FIG. 17 schematically illustrates a cross-section of a skirt portion outer peripheral surface according to a sixth embodiment.

FIG. 18 illustrates a cross-section of the skirt portion outer peripheral surface in a result of an experiment according to the sixth embodiment.

### DESCRIPTION OF EMBODIMENTS

In the following description, how to implement a piston and a method for processing a surface thereof according to one embodiment of the present invention will be described with reference to the drawings.

### First Embodiment

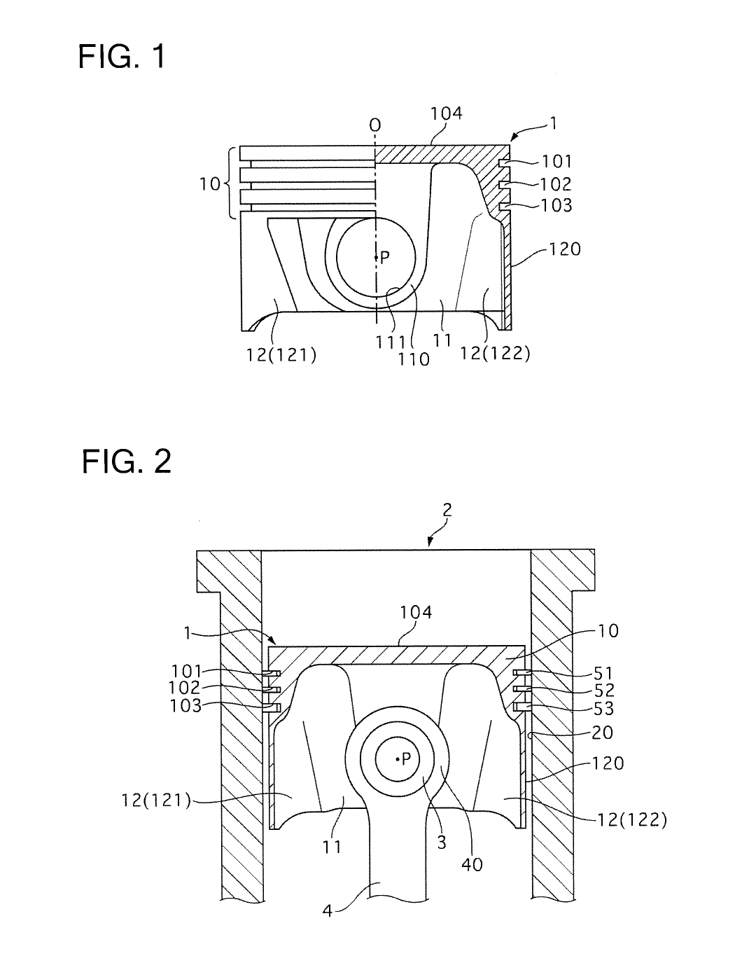

First, a configuration will be described. FIG. 1 illustrates a piston 1 of an internal combustion engine (hereinafter referred to as an engine) according to the present embodiment as viewed from a direction in which a central axis P of a piston pin hole 111 extends. A right half illustrates a cross-section of the piston 1 in a plane containing a central axis O of the piston 1. The engine is, for example, a four-cycle gasoline engine but is not limited thereto. The piston 1 is reciprocatably contained in a cylinder 2 of the engine. FIG. 2 illustrates cross-sections of the piston 1 and the cylinder 2 coupled to a connecting rod (con rod) 4 taken along a plane containing the central axis O and extending perpendicularly to the central axis P. The cylinder 2 is formed into a cylinder block, and an inner wall 20 thereof (a wall surface inside the cylinder 2) is generally cylindrical. In other words, the inner wall 20 of the cylinder 2 (hereinafter referred to as the cylinder inner wall 20) is generally circular in a plane perpendicular to a central axis of the cylinder 2. A cylinder head is mounted on the cylinder block. The cylinder head closes an opening of the cylinder 2. A combustion chamber is defined between a crown surface 104 of the piston 1, the cylinder inner wall 20, and the cylinder head. The piston 1 is coupled to one end side (a small end portion 40) of the con rod 4 via a piston pin 3. The other end side (a large end portion) of the con rod 4 is coupled to a crankshaft.

The piston 1 is formed by casting or the like with use of aluminum alloy (for example, Al—Si AC8A) as a parent material (a base material). The piston 1 has a bottomed cylindrical shape, and includes a head portion 10, apron portions 11, and skirt portions 12. The head portion 10 includes the crown surface 104 at a crown portion thereof. The head portion 10 is hollow on an inner peripheral side of a portion other than the crown portion. Three ring grooves 101, 102, and 103 extend on an outer peripheral surface of the head portion 10 in a circumferential direction of the piston 1 (a direction around the central axis O). Compression rings 51 and 52 are placed in the ring grooves 101 and 102 located closer to the crown surface 104, respectively, and an oil ring 53 is placed in the ring groove 103 located farther away from the crown surface 104. The apron portions 11 and the skirt portions 12 are located on an opposite side from the crown surface 104 with respect to the ring grooves 101 to 103 in a direction in which the central axis O of the piston 1 extends (a central-axis direction). The skirt portions 12 and the apron portions 11 are hollow on inner peripheral sides thereof. The pair of apron portions 11 are provided on both radial sides of the piston 1 with the central axis O sandwiched therebetween. Each of the apron portions 11 includes a pin boss 110. Each of the pin bosses 110 includes the piston pin hole ill. The piston pin hole 111 extends in the radial direction of the piston 1 while penetrating through the pin boss 110. An end of the piston pin 3 is fitted to the piston pin hole 111. An outer peripheral surface of the apron portion 11 is located closer to the central axis O than an outer peripheral surface of the head portion 10 (the skirt portions 12) is. The pair of skirt portions 12 are provided on the both radial sides of the piston 1 with the central axis O sandwiched therebetween. The skirt portions 12 include a thrust-side skirt portion 121 and an opposite thrust-side skirt portion 122. The skirt portions 12 are sandwiched by both the apron portions 11 in the circumferential direction of the piston 1. The skirt portions 12 are thinner than the apron portions 11. An outer peripheral surface 120 of each of the skirt portions 12 (hereinafter referred to as the skirt portion outer peripheral surface) has a circular-arc shape in the plane perpendicular to the central axis O. Twice a distance from the central axis O to the skirt portion outer peripheral surface 120 (an outer diameter of the skirt portions 12) is slightly larger than an outer diameter of the head portion 10, and is slightly smaller than a diameter of the cylinder inner wall 20 (an inner diameter of the cylinder 2).

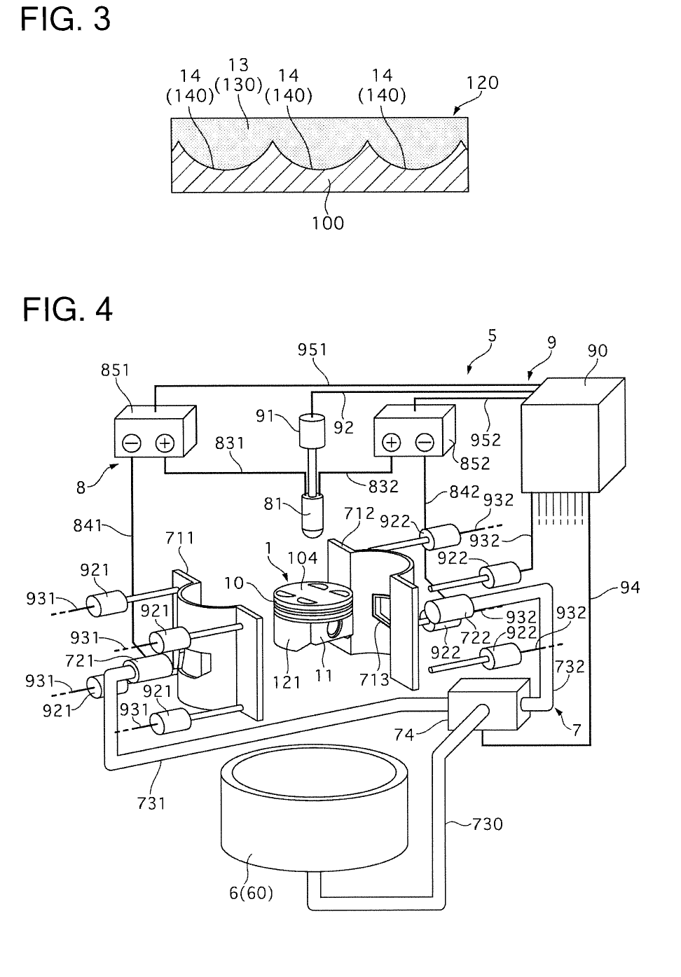

FIG. 3 illustrates a (partial) cross-section of the outer peripheral side of the skirt portion 12 in the plane containing the central axis O. The skirt portion outer peripheral surface 120 is covered by at least one film portion 13. In the present embodiment, the film portion 13 includes only a single layer that is electrodeposited film 130. The base material 100 of the piston 1 is covered by the single layer that is electrodeposited film 130 on the skirt portion outer peripheral surface 120, and this electrodeposited film 130 is exposed on the skirt portion outer peripheral surface 120 (in other words, the electrodeposited film 130 directly faces the cylinder inner wall 20, the meaning of being exposed also applies hereinafter). The piston 1 includes streaks 14 on the skirt portion outer peripheral surface 120. The steaks 14 are streaked grooves extending in the circumferential direction of the piston 1. The plurality of streaks 14 are lined up adjacent to each other in the central-axis direction of the piston 1. Each of the streaks 14 includes a streak 140 on the base material 100 of the piston 1. The streak 140 is spirally formed around the central axis O by, for example, turning processing with use of a turning tool or rolling processing with use of a roller. A cross-sectional shape of the streak 140 (a shape in the plane containing the central axis O) is a U shape or a V shape in conformity to a shape of a blade edge of a processing tool. The cross-sectional shape of the streak 140 may be a stepped shape due to, for example, the processing performed partially redundantly. A shape of a portion between the adjacent streaks 140 (hereinafter referred to as a top) may be a protruding shape (having a pointed tip) or a planer shape (having a flat tip). A distance between the adjacent streaks 140 (a pitch of the streak) is a predetermined value within a range from several dozen μm to several hundred μm (for example, approximately 250 μm). A height or a depth of the streak 140 is a predetermined value within a range of several μm to several dozen μm (for example, approximately 10 μm). Now, the height (the depth) of the streak 14 refers to a distance from a lowermost portion to an uppermost portion (the top) of this streak 14 in a normal direction of the skirt portion outer peripheral surface 120 (the radial direction of the piston 1). A direction in which the streak 140 extends along the skirt portion outer peripheral surface 120 may be any direction as long as this direction is angled with respect to the central-axis direction of the piston 1, and the streak 140 may, for example, extend obliquely with respect to the circumferential direction of the piston 1. The streak 140 may snake in a wavelike manner instead of extending linearly. The shape and the size of the streak 140 may be changed according to the position and the range of the skirt portion 12.

The electrodeposited film 130 is a film formed by electrodeposition coating. More specifically, the electrodeposited film 130 is formed by electrodepositing an electrodeposition coating material on the skirt portion outer peripheral surface 120. The electrodeposited film 130 functions as a decorative layer for improving smoothness of the skirt portion outer peripheral surface 120. The electrodeposited film 130 contains a resin (a binder resin) as a binding agent (a binder) having an adhesion property to another material. A resin having an excellent heat resistance property and abrasion resistance property, such as a polyamide-imide resin (hereinafter referred to as PAI), is used as the binder resin. The electrodeposited film 130 may contain, as the binder resin, another binder resin, such as at least one of a polyimide resin (hereinafter referred to as PI) or an epoxy resin (hereinafter referred to as EP), together with or instead of PAI. PI has an excellent heat resistance property and abrasion resistance similarly to PAI. PAI, PI, and EP also have an excellent adhesion property. Further, the electrodeposited film 130 may contain an additive other than the binder resin. The electrodeposited film 130 does not contain a conductive solid lubricant, such as graphite and molybdenum disulfide.

The film portion 13 (the electrodeposited film 130 in the present embodiment) is formed so as to cover the skirt portion outer peripheral surface 120 in processing of the surface of the piston 1. A method for processing the surface of the piston 1 includes a process for forming the electrodeposited film. In the process for forming the electrodeposited film, an electrodeposition coating process, a water washing process, a burning process, and a cooling process are performed in this order. Processing for, for example, removing oil and contamination from the skirt portion outer peripheral surface 120 of the piston 1 (the base material 100), which is a coating target, may be performed before the electrodeposition coating process to, for example, improve the adhesiveness of the film portion 13. In the electrodeposition coating process, the skirt portion 12 of the piston 1, which is the coating target, is dipped in an aqueous electrodeposition coating material, and the electrodeposition coating material side is formed as an opposite electrode. For example, in a case where an anionic coating material is used, the skirt portion 12 is formed as an anode and the electrodeposition coating material side is formed as a cathode. The polarity may be reversed with use of a cationic coating material. The electrodeposition coating material is prepared by, for example, dissolving or dispersing (into a colloid state) the binder resin serving as a base in water. An organic solvent, a neutralizer, an additive, and/or the like are added as necessary. The electrodeposition can be carried out by a constant current method or a constant voltage method. A direct-current voltage is applied between the electrodes to cause a direct current to pass therethrough under predetermined electrodeposition conditions. The electrodeposition conditions are, for example, a voltage of several dozen V to several hundred V and a processing time (a power supply time) of several seconds to several dozen seconds. When the current passes through, the water in the electrodeposition coating material is electrolytically decomposed and coating material particles including the binder resin are ionized, and these coating material particles are electrophoresed toward one side where the skirt portion 12 as the electrode is located. The coating material particles precipitated on the skirt portion outer peripheral surface 120 are fused due to Joule heat generated from an electric resistance, and are deionized and become insoluble. As a result, an electrically insulating (exhibiting a non-conductive resistance) film (the electrodeposited film 130) covering the base material 100 is formed on the skirt portion outer peripheral surface 120. A thickness (a film thickness) of the electrodeposited film 130 can be appropriately adjusted according to the electrodeposition conditions.

FIG. 4 schematically illustrates a first example of an apparatus 5 for performing the electrodeposition coating process. The apparatus 5 includes an electrodeposition coating material reservoir unit 6, an electrodeposition coating material delivery unit 7, a power supply unit 8, and a control unit 9. The electrodeposition coating material reservoir unit 6 includes a liquid tank 60. The liquid tank 60 reserves the electrodeposition coating material therein. The electrodeposition coating material delivery unit 7 includes masking plates 71, nozzles 72, a pipe conduit 73, and a pump 74. The pair of masking plates 71 are disposed on both the radial sides of the piston 1. A masking plate 711, which is one of the making plates 71, covers a region other than the thrust-side skirt portion 121 on the outer peripheral surface of the piston 1 on one radial side. A masking plate 712, which is the other of the masking plates 71, covers a region other than the opposite thrust-side skirt portion 122 on the outer peripheral surface of the piston 1 on the other radial side. A seal member (an O-ring) 713 is disposed between the making plates 71 and the outer peripheral surface of the piston 1 so as to surround the skirt portion 12. The pair of nozzles 72 are disposed on both the radial sides of the piston 1. A nozzle 721, which is one of the nozzles 72, faces the thrust-side skirt portion 121. A nozzle 722, which is the other of the nozzles 72, faces the opposite thrust-side skirt portion 122. These nozzles 721 and 722 are connected to the pump 74 via pipe conduits 731 and 732, respectively. The pump 74 is connected to the liquid tank 60 via a pipe conduit 730. The pump 74 introduces the electrodeposition coating material from the liquid tank 60 therein, and discharges the electrodeposition coating material toward the nozzles 72 side.

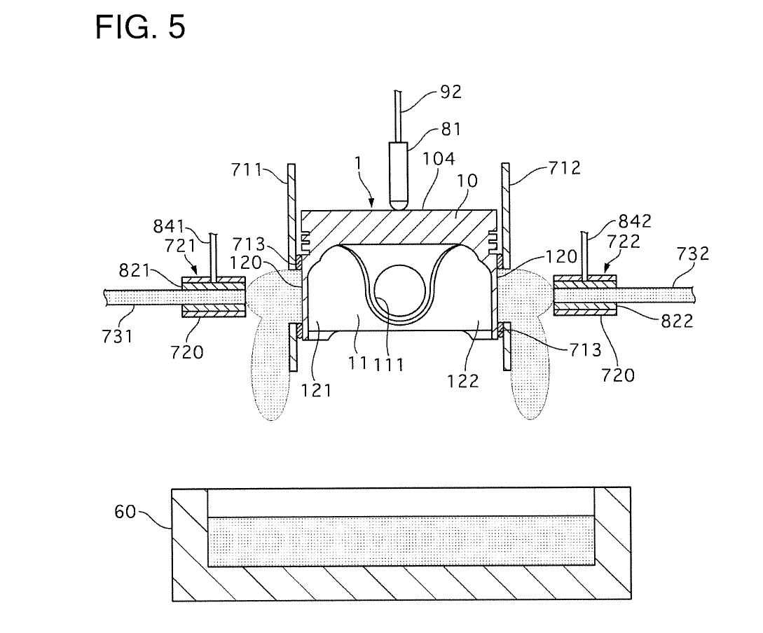

The power supply unit 8 includes electrodes, electrodeposition wirings 83 and 84, and a power source 85. The electrodes include an anode 81 and a cathode 82. The anode 81 is disposed the piston 1 side. The anode 81 has a rod-like shape, and a distal end thereof faces the crown surface 104 of the piston 1. The cathode 82 has a cylindrical shape, and is disposed on an inner peripheral side of each of the nozzles 72 (the electrodeposition coating material side). An inner peripheral side of the cathode 82 is in contact with the electrodeposition coating material. An outer peripheral side of the cathode 82 is covered by an insulating member 720 (refer to FIG. 5). The anode 81 is connected to the power source 85 via the electrodeposition wiring 83. The cathode 82 is connected to the power source 85 via the electrodeposition wiring 84. The control unit 9 includes a console 90, actuators, and control wirings 92 to 94. The actuators include an anode driving actuator 91, a masking plate driving actuator 92, and a pump driving actuator. The anode driving actuator 91 can press the anode 81 against the crown surface 104 of the piston 1 and separate the anode 81 from the crown surface 104 of the piston 1. The masking plate driving actuator 92 can press the masking plate 71 against the outer peripheral surface of the piston 1 and separate the masking plate 71 from the outer peripheral surface of the piston 1. The pump driving actuator drives the pump 74. These actuators are connected to the console 90 via the control wirings 92, 93, and 94, respectively. The power source 85 is connected to the console 90 via a control wiring 95. Positions of the masking plate 71 and the anode 81, an activation state of the pump 74, and a state of power supply to the electrodes 81 and 82 are controlled by the console 90. FIG. 5 schematically illustrates how the electrodeposition coating process is performed by the apparatus 5. FIG. 5 illustrates a cross-section of the piston 1 and the like in the plane containing the central axis O of the piston 1 as viewed from the direction in which the central axis P of the piston pin hole 111 extends. Peripheries of the respective outer peripheral surfaces 120 of the skirt portions 121 and 122 are masked by the masking plates 711 and 712, respectively. The electrodeposition coating material discharged from the pump 74 is injected toward the skirt portions 121 and 122 from the individual nozzles 721 and 722, respectively, hits the skirt portion outer peripheral surfaces 120, and then falls due to the force of gravity to return to inside the liquid tank 60. The binder resin in the electrodeposition coating material is electrophoresed during the injection from one side where the inner peripheral surface of the cathode 82 disposed in the nozzle 72 is located toward the skirt portion outer peripheral surface 120 serving as the anode.

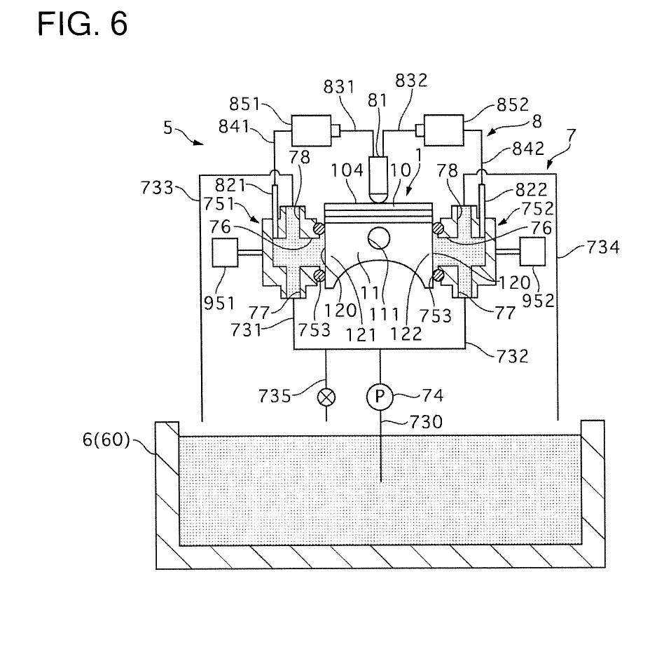

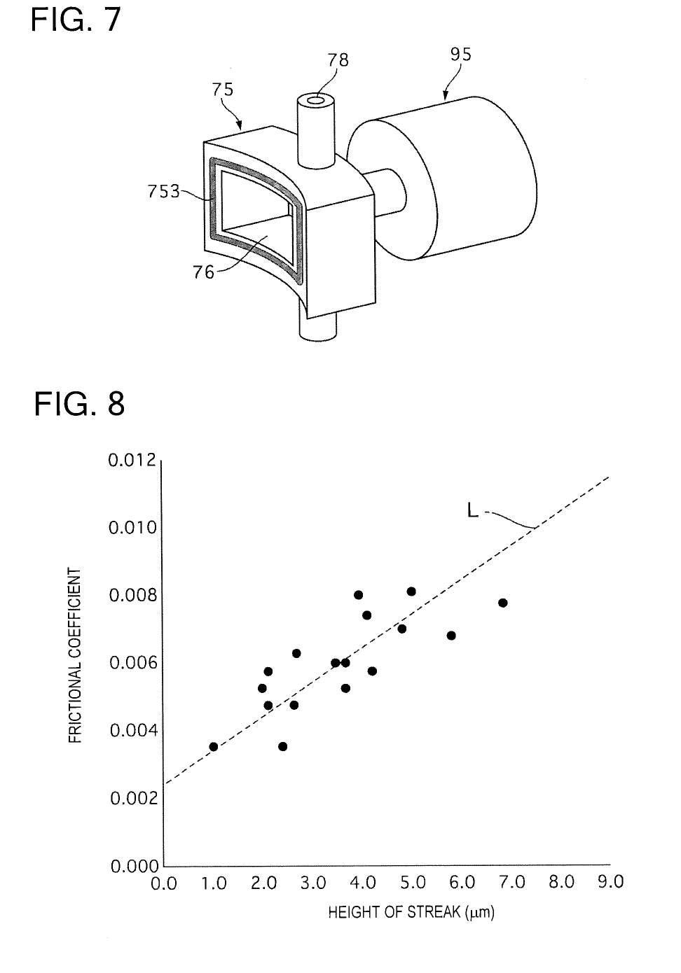

FIG. 6 is a cross-sectional view schematically illustrating a second example of the apparatus 5. The electrodeposition coating material delivery unit 7 includes liquid passage members 75 (751 and 752). The actuators include liquid passage member driving actuators 95 (951 and 952). The pair of liquid passage members 75 and the pair of liquid passage member driving actuators 95 are disposed on both the radial sides of the piston 1. FIG. 7 is a perspective view schematically illustrating the liquid passage member 75 and the liquid passage member driving actuator 95. The liquid passage member 75 is made from a conductive material, and includes an opening portion 76 shaped generally similarly to the skirt portion outer peripheral surface 120. The opening portion 76 faces the skirt portion outer peripheral surface 120. A seal member (an O-ring) 753 is disposed between a portion around the opening portion 76 of the liquid passage member 75 and the outer peripheral surface of the piston 1 so as to surround the skirt portion outer peripheral surface 120. The liquid passage member 75 forms a liquid passage including the skirt portion outer peripheral surface 120 and the inner peripheral surface of the liquid passage member 75 as a part thereof. More specifically, the liquid passage member 75 includes two opening portions 77 and 78 in addition to the opening portion 76. The opening portion 77, which is one of these two opening portions, is connected to the pump 74 via a pipe conduit 731 or 732. The opening portion 78, which is the other of these two opening portions, is connected to the liquid tank 60 via a pipe conduit 733 or 734. The liquid passage connecting the pump 74 and the liquid tank 60 to each other via the liquid passage member 75 uses the inner peripheral surface of the liquid passage member 75 and the skirt portion outer peripheral surface 120 as a part thereof. A drain pipe conduit 735 is connected to the pipe conduit 731 connecting the pump 74 and the liquid passage member 75 to each other. The pipe conduit 735 is opened to the liquid tank 60. A drain valve is provided in the pipe conduit 735. The cathode 82 is set on the liquid passage member 75. The liquid passage member driving actuator 95 can press the liquid passage member 75 against the outer peripheral surface of the piston 1 and separate the liquid passage member 75 from the outer peripheral surface of the piston 1. A position of the liquid passage member 75 is controlled by the console 90. Other configurations of the apparatus 5 are similar to the first example. The pump 74 introduces the electrodeposition coating material therein from the liquid tank 60 via the pipe conduit 730, and discharges the electrodeposition coating material toward the liquid passage member 75 side. The electrodeposition coating material discharged from the pump 74 returns to the liquid tank 60 by passing through the liquid passage defined by the liquid passage member 75. When passing through the liquid passage defined by the liquid passage member 75, the electrodeposition coating material is in contact with the skirt portion outer peripheral surface 120. The binder resin in the electrodeposition coating material is electrophoresed from one side where the inner peripheral surface of the liquid passage member 75 serving as the cathode is located toward the skirt portion outer peripheral surface 120 serving as the anode.

A third example of the apparatus 5 includes a liquid tank, electrodes, electrodeposition wirings, and a power source. An anode is set on the crown surface 104 of the piston 1, and a cathode is set in the electrodeposition coating material in the liquid tank. These electrodes are connected to the power source via the electrodeposition wirings, respectively. The piston pin hole 111 of the piston 1 is plugged for the masking. Power is supplied with a portion of this piston 1 other than the head portion 10 (the skirt portions 12 and the apron portions 11) dipped in the electrodeposition coating material in the liquid tank. The first example is most preferable and the second example is second most preferable from the view point of efficiently forming the electrodeposited film 130 on the skirt portion outer peripheral surface 120. The third example is preferable from the view point of simplification of the apparatus 5.

In the water washing process, remaining liquid is removed by washing the skirt portion 12 (the electrodeposited film 130) after the electrodeposition coating process, with water. This process improves a finished quality and overcoatability. The water washing process may be omitted. After that, when the skirt portion 12 is dried by heating (baking drying), a solvent is volatilized and the resin is also polymerized and cured on the electrodeposited film 130. The electrodeposited film 130 is cured, and also adheres to the skirt portion outer peripheral surface 120. In the burning process, the skirt portion 12 (the electrodeposited film 130) after the water washing process is burned under predetermining burning conditions. Burning the skirt portion 12 improves the hardness and adhesiveness of the electrodeposited film 130, compared to simple baking drying (for example, 90 degrees Celsius to 120 degrees Celsius without a holding time). The burning conditions are, for example, 180 degrees Celsius and 30 minutes. The skirt portion 12 can be burned even under a low temperature as low as 200 degrees Celsius or lower, and therefore the burning process can be easily applied even in the case where the base material 100 of the piston 1 is aluminum alloy: In the cooling process, the skirt portion 12 (the electrodeposited film 130) after the burning process is cooled. The skirt portion 12 may be cooled naturally (by just being left unattended) without being forcibly cooled.

Next, functions and effects will be described. A rotational motion of the crankshaft is converted into a reciprocating motion of the piston 1. When the piston 1 reciprocates inside the cylinder 2, the outer peripheral surface 120 in the surface of the skirt portion 12 is slidably moved relative to the cylinder inner wall 20. This movement prevents or reduces an oscillation operation of the piston 1 around the central axis P of the piston pin 3 inside the cylinder 2, thereby smoothing the reciprocating motion of the piston 1 and also preventing or reducing hitting noise. In the present specification, the slidable movement includes both a movement of the skirt portion outer peripheral surface 120 (even partially) relative to the cylinder inner wall 20 while contacting this inner wall 20 as a contact between solid objects without intervention of an oil membrane of engine oil, and a movement of the skirt portion outer peripheral surface 120 relative to the cylinder inner wall 20 in a state facing the cylinder inner wall 20 via the oil membrane (i.e., without causing the contact between the solid objects). The con rod 4 is inclined with respect to the central axis of the cylinder 2 according to a crank angle. In an expansion stroke (a combustion stroke) or a compression stroke, a pressure is applied from one side where the crown surface 104 of the piston 1 is located. Balance between forces causes the thrust-side skirt portion 121 to be pressed against the cylinder inner wall 20 (a thrust side) when the piston 1 is stroked toward a bottom dead center side in the expansion stroke. When the piston 1 is stroked toward a top dead center side in the compression stroke, the opposite thrust-side skirt portion 122 is pressed against the cylinder inner wall 20 (an opposite thrust side). A force by which the skirt portion outer peripheral surface 120 is pressed against the inner wall (a surface pressure on a surface slidably moved relative to the cylinder inner wall 20) is stronger on the thrust-side skirt portion 121, which is in pressure contact with the cylinder inner wall 20 by receiving a combustion pressure, than on the opposite thrust-side skirt portion 122.

Generally, it is difficult to keep even a distribution of the force (the surface pressure or a load) by which the skirt portion outer peripheral surface 120 is pressed against the cylinder inner wall 20. Normally, a high surface pressure region where the surface pressure is relatively high and a low surface pressure region where the surface pressure is relatively low are generated on the skirt portion outer peripheral surface 120. A partial range in the skirt portion outer peripheral surface 120 (this will be hereinafter referred to as a first range) has a larger bump and dent than a thickness of the oil membrane between the skirt portion outer peripheral surface 120 and the cylinder inner wall 20, thereby forming the high surface pressure region. On the other hand, a range other than the first range in the skirt portion outer peripheral surface 120 (this will be hereinafter referred to as a second range) has a smaller bump and dent than the thickness of the oil membrane between the skirt portion outer peripheral surface 120 and the cylinder inner wall 20, thereby forming the low surface pressure region.

While the formation of the oil membrane is easily impeded between the first range and the cylinder inner wall 20, the oil membrane is easily formed between the second range and the cylinder inner wall 20, in the skirt portion outer peripheral surface 120. There is such a situation where, after an operation of the engine is started, the first range (even partially) is slidably moved while contacting the cylinder inner wall 20 as the contact between the solid objects without the intervention of the oil membrane. For example, around the top dead center of the piston 1, the oil membrane is especially difficult to be formed between the cylinder inner wall 20 and the first range due to, for example, a reduction in a speed of the piston 1 and an increase in the load. When the thickness of the oil membrane reaches or falls below surface roughness of them (a lubrication gap reaches or falls below a lower limit value), boundary lubrication is established as the lubrication therebetween, so that a solid contact further frequently occurs therebetween. More specifically, depending on the scene, because a parameter based on conditions such as the load and the speed in a Stribeck curve is located in a boundary lubrication region between the cylinder inner wall 20 and the first range, a frictional coefficient may increase and a scuff may be generated therebetween. On the other hand, the second range is slidably moved relative to the cylinder inner wall 20 with the oil membrane formed between the skirt portion outer peripheral surface 120 and the cylinder inner wall 20 in many scenes, while the engine is in operation. In other words, the thickness of the oil membrane exceeds the surface roughness of them (the lubrication gap exceeds the lower limit value), and fluid lubrication is established as the lubrication therebetween, so that no solid contact occurs therebetween. In other words, in many scenes, the above-described parameter in the Stribeck curve is located in a fluid lubrication region between the cylinder inner wall 20 and the second range, so that the frictional coefficient is reduced and the scuff less likely occurs therebetween.

In the present embodiment, an exposure of the base material 100 of the piston 1 on the skirt portion outer peripheral surface 120 including the first range is prevented or reduced by the electrodeposited film 130. A contact between the base material 100 and the cylinder inner wall 20 as the contact between the soil objects is prevented or reduced in the first range in the skirt portion outer peripheral surface 120, which improves a scuff resistance property of the piston 1. PAI and PI have the excellent abrasion resistance property and heat resistance property, and therefore detachment of the electrodeposited film 130 from the base material 100 is prevented or reduced. Therefore, in the case where the electrodeposited film 130 contains PAI or PI as the binder resin, the above-described effects are improved. The electrodeposited film 130 does not contain the solid lubricant while containing the binder resin (the electrodeposited film 130 is a layer containing the resin alone). Therefore, the electrodeposited film 130 exerts a strong adhesion force, and excellent adhesiveness is achieved between the electrodeposited film 130 and the base material 100. Further, the electrodeposited film 130 is cured by being burned. As a result, the detachment of the electrodeposited film 130 from the base material 100 is prevented or reduced.

The electrodeposited film 130 (the electrodeposition coating material) may contain a solid lubricant that is an electric insulator, such as a fluoropolymer (polytetrafluoroethylene, hereinafter referred to as PTFE). In this case, even when the electrodeposited film 130 is in contact with the cylinder inner wall 20 in the first range, the above-described solid lubricant contributes to a reduction in the strength of the frictional force between the skirt portion outer peripheral surface 120 and the cylinder inner wall 20. In the present embodiment, the electrodeposited film 130 is located on an uppermost layer, and is exposed on the skirt portion outer peripheral surface 120. Therefore, the above-described function of reducing the frictional force (lubricity) can be acquired at a further early stage after the operation of the engine is started. In this case, the abrasion property and the adhesiveness of the electrodeposited film 130 can be adjusted by adjusting contained amounts of the solid lubricant and the binder resin in the electrodeposited film 130. For example, this adjustment will be described, supposing that the contained amount of the solid lubricant is 50% by weight (hereinafter referred to as wt %) or more and 95 wt % or less and the contained amount of the binder resin is 5 wt % or more and 50 wt % or less, in the electrodeposited film 130. The electrodeposited film 130 is easily abraded since the contained amount of the solid lubricant is 50 wt % or more (the contained amount of the binder resin is 50 wt % or less). Therefore, initial conformability when the skirt portion outer peripheral surface 120 is moved slidably relative to the cylinder inner wall 20 is improved. Further, the adhesion force of the electrodeposited film 130 is secured to some degree since the contained amount of the binder resin is 5 wt % or more (the contained amount of the solid lubricant is 95 wt % or less). Therefore, a reduction in the adhesiveness between the electrodeposited film 130 and the base material 100 is prevented or cut down. On the other hand, in a case where the contained amount of the solid lubricant is more than 0 wt % and 50 wt % or less and the contained amount of the binder resin is 50 wt % or more and less than 100 wt % in the electrodeposited film 130, the electrodeposited film 130 exerts a strong adhesion force since the contained amount of the binder resin is 50 wt % or more (the contained amount of the solid lubricant is 50 wt % or less). Therefore, excellent adhesiveness is achieved between the electrodeposited film 130 and the base material 100.

Generally, the streak is formed and caused to exert a lubrication function on the skirt portion outer peripheral surface to, for example, prevent or reduce the generation of the scuff. More specifically, the engine oil (hereinafter referred to as the oil) is stored in the streak and is held in the streak even while the engine is out of operation. The held oil is supplied to between the skirt portion outer peripheral surface and the cylinder inner wall as appropriate. For example, a loss of the oil is prevented or reduced when the engine is started from a stopped state or when the piston reciprocates rapidly. This effect prevents or reduces the generation of the scuff between the skirt portion outer peripheral surface and the cylinder inner wall and smooths the reciprocating motion of the piston due to a reduction in the frictional force therebetween. On the other hand, the present inventor has found out the following fact. That is, the frictional coefficient under the fluid lubrication between the skirt portion outer peripheral surface 120 and the cylinder inner wall 20 (hereinafter referred to as a fluid lubrication frictional coefficient) has a close relationship with the height of the streak 14 on the skirt portion outer peripheral surface 120, and the fluid lubrication frictional coefficient reduces as the height of the streak 14 reduces (as the skirt portion outer peripheral surface 120 is further smoothed). As the height of the streak 14 reduces, a shear resistance of the oil membrane between the skirt portion outer peripheral surface 120 and the cylinder inner wall 20 reduces, and it is considered that this contributes to the reduction in the fluid lubrication frictional coefficient. The above-described height of the streak 14 on the skirt portion outer peripheral surface 120 refers to the height of the streak 140 processed on the base material 100 in a case where the film portion 13 does not cover the base material 100 of the piston 1, and refers to a height of a groove (the steak 14) on this film portion 13 that is formed (consequently) at a portion corresponding to the streak 140 processed on the base material 100 in a case where the film potion 13 covers the base material 100.

An experiment was conducted to study the relationship between the height of the streak 14 on the skirt portion outer peripheral surface 120 and the fluid lubrication frictional coefficient. In this experiment, a chip (block)-on-disk type friction/abrasion testing machine was used. A surface of a testing piece (made from ΔC8A) imitating the skirt portion 12 where a streak was formed was placed in abutment with a surface (surface roughness: average 0.5 μmRa (min. 0.42 to max. 0.66)) of a disk (made from FC250) imitating the cylinder inner wall 20. The disk was rotated at a predetermined speed with a predetermined load (surface pressure) and lubricant oil provided thereto. A direction in which the surface of the disk was slidably moved relative to the surface of the testing piece was a direction generally perpendicular to a direction in which the streak extended. A supply amount of the lubricant oil and other conditions were adjusted so as to establish the fluid lubrication. The frictional coefficient (the fluid lubrication frictional coefficient) at the time of the slidable movement was measured while the height of the streak was changed a plurality of times. FIG. 8 illustrates a result of measuring the frictional coefficient with respect to each height of the streak when the testing conditions were set to the surface pressure: 2.8 Mpa, the speed: 2.0 m/sec, the supply amount of the lubricant oil (a grade thereof was 5W-30): 40 ml/min. A plurality of pieces of data (a plurality of points in a graph) indicating the measurement result is contained in a region of a predetermined range centered at one straight line L. The above-descried straight line L indicates that the above-described frictional coefficient is changed proportionally to the height of the streak. This experiment result reveals that the fluid lubrication frictional coefficient is lower when the streak 14 on the skirt portion outer peripheral surface 120 is short than when the streak 14 is tall.

Due to the electrodeposited film 130, the smoothness of the skirt portion outer peripheral surface 120 is improved. More specifically, a bottom of the streak 140 is buried by the electrodeposited film 130 in the process for forming the electrodeposited film, by which the height of the streak 14 reduces (the streak shape is smoothed) as schematically illustrated in FIG. 3. After the skirt portion outer peripheral surface 120 is covered by the electrodeposited film 130, the smoothness of the skirt portion outer peripheral surface 120 is improved compared to before the skirt portion outer peripheral surface 120 is covered by the electrodeposited film 130. The improvement of the smoothness leads to a reduction in the frictional coefficient (the fluid lubrication frictional coefficient) when the skirt portion outer peripheral surface 120 contacts the oil and the fluid lubrication is established. Therefore, engine efficiently (fuel efficiency) is improved. While the engine is in operation, the friction (and an energy loss due to this friction) between the skirt portion outer peripheral surface 120 and the cylinder inner wall 20 is mainly constituted by a friction under the boundary lubrication and a friction under the fluid lubrication. Then, the latter friction occupies a considerably larger percentage of the whole than a percentage of the whole that is occupied by the former friction regardless of the operation condition and the stroke of the piston 1. The latter friction (the friction under the fluid lubrication) reduces due to the electrodeposited film 130, by which the friction (and the energy loss) as a whole generated on the skirt portion outer peripheral surface 120 can efficiently reduce. The film thickness of the electrodeposited film 130 can be appropriately selected within a range that can acquire the above-described smoothing effect.

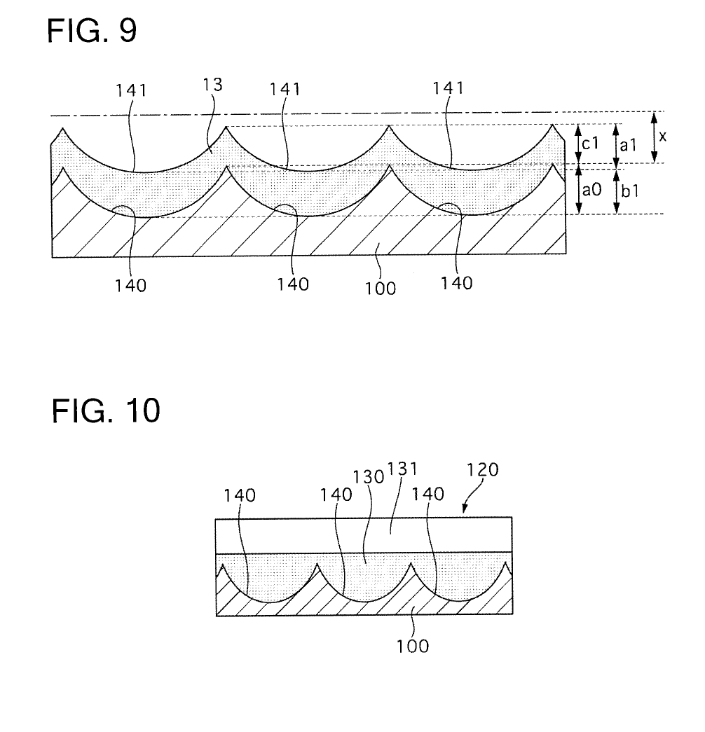

Then, the reduction in the height of the streak 14 (the improvement of the smoothness) due to the electrodeposited film 130 has the following meaning. That is, a new streak 141 is formed (consequently) at the portion corresponding to the streak 140 processed on the base material 100 (the portion covering this streak 140) on the surface of the film portion 13 covering the base material 100 of the piston 1. The height of the streak 141 is shorter on the electrodeposited film 130 than on a common film portion 13 (not formed by the electrodeposition). This will be specifically described with reference to the drawing. FIG. 9 schematically illustrates the cross-section of the outer peripheral side of the skirt portion 12 similarly to FIG. 3. Assume that a0 represents the height of the streak 140. Assume that a1 represents a height of the steak 141 formed on the film portion 13 directly covering the base material 100. Assume that b1 represents a distance from the lowermost portion of the streak 140 to a lowermost portion of the streak 141. Assume that c1 represents a distance from the uppermost portion (the top) of the streak 140 to an uppermost portion (a top) of the streak 141. The following equation (1) is established.

a1=a0+c1−b1 (Equation 1)

Generally, the coating material contains a volatile component such as the solvent, and a solid component such as the resin. The solid component remains as the film even after the coating material is dried (the volatile component is volatilized). The volatile component is volatilized from the coating material, and does not remain as the film. Hypothetically suppose that, after the coating process, the surface of the film portion 13 before the volatile component in the coating material is volatilized is a completely smooth surface without any bump and dent formed thereon regardless of whether the surface is the portion corresponding to the streak 140 as indicated by an alternate long and short dash line in FIG. 9. Assume that x represents a distance from the uppermost portion (the top) of the streak 140 to the surface of the film portion 13 before the above-described volatilization. A distance from the lowermost portion of the streak 140 to the surface of the film portion 13 before the above-described volatilization is (a0+x). Assuming that a represents a ratio of a volume of the solid component to a volume of the entire coating material (a sum of a volume of the volatile component and the volume of the solid component), the following equations (2) and (3) are established.

b1=(a0+x)α (Equation 2)

c1=αx (Equation 3)

The ratio α ranges from 0.3 to 0.5 for a normal coating material, but ranges from 0.1 to 0.6 if also containing special types. The following equation (4) is established from the above-described equations (1) to (3).

a1=a0+αx−α(a0+x)=(1−α)a0 (Equation 4)

In other words, even if the coated film is flat at the portion corresponding to the streak 140 in the state before the volatile component in the coating material is volatized, the streak 141 is formed on the surface of the film portion 13 due to the volatilization of the volatile component from this coated film. (1−α)a0 is the height of this streak 141. The streak 141 of this film portion 13 becomes shorter than the original streak 140 by an amount corresponding to the volume ratio α of the solid component in the coating material of the film portion 13. The reduction in the height of the streak 14 (the improvement of the smoothness) due to the electrodeposited film 130 means that a1 becomes shorter than (1−α)a0, and therefore is expressed by the following equation (5).

a1<(1−α)a0 (Equation 5)

In other words, the streak 141 of the electrodeposited film 130 becomes shorter than the original streak 140 by a larger amount than the amount corresponding to the volume ratio α of the solid component in the electrodeposition coating material.

As indicated by the above-described equation (4), due to the volatilization of the volatile component of the coating material from the coating material of the film portion 13, the streak 14 of this film portion 13 is formed so as to have a height as tall as the height obtained by the original streak 14 being multiplied by the volume ratio (1−α) of the above-described volatile component. In other words, by the amount corresponding to the volume ratio α of the solid component in the coating material of the film portion 13, the streak 14 of this film portion 13 becomes shorter than the original streak 14. Therefore, stacking several common films that are not the electrodeposited film 130 allows the skirt portion outer peripheral surface 120 to be smoothed to a similar level to the smoothness achieved by the virtue of the electrodeposited film 130. In the present embodiment, the use of the electrodeposited film 130 makes the streak 14 shorter by the larger amount than the amount corresponding to the volume ratio α, as indicated by the above-described equation (5). The skirt portion outer peripheral surface 120 is efficiently smoothed with use of the electrodeposited film 130 alone without requiring several films to be stacked. Therefore, the process for manufacturing the piston 1 can be simplified. The skirt portion 12 may include not only one electrodeposited film 130 but also a plurality of electrodeposited films 130. The skirt portion 12 according to the present embodiment includes only one electrodeposited film 130. The present embodiment does not require several electrodeposited films 130 to be stacked, and therefore can simplify the process for manufacturing the piston 1.

One conceivable mechanism of smoothing the skirt portion outer peripheral surface 120 (reducing the height of the streak) due to the electrodeposited film 130 is, for example, the following mechanism. In the electrodeposition coating process, the coating material precipitated on the skirt portion outer peripheral surface 120 during the power supply loses the conductivity. In other words, the electric resistance increases and the flow of the current is stopped. Therefore, the growth of the film is stopped, so that a thin film even in thickness should be formed on the skirt portion outer peripheral surface 120. However, a heat release state of the Joule heat is different between the bottom (a groove) and the top (a ridge) of the streak 14. It is considered that this contributes to the smoothness. More specifically, a heat release performance is excellent on the top of the streak 14 but the heat is confined on the bottom of the streak 14. Therefore, the film growth due to the fusion of the coating material particles is more sped up on the bottom. On the other hand, even after the coating material is precipitated on the skirt portion outer peripheral surface 120, the film becomes porous due to gas generated from the electrolysis, so that the electric resistance of the film does not increase so much actually and the flow of the current continues. Therefore, the film continues growing and the film grows more quickly on the bottom of the streak 14. As a result, the formation of the even film thickness is impeded, and the film is formed so as to fill the bottom of the streak 14. The film in the porous state is formed into a continuous film by being melted and flowing in the next burning process (the baking drying).

The piston 1 does not necessarily have to include the streak 140. In other words, the electrodeposited film 130 may be provided on the piston 1 unequipped with the streak 140 on the base material 100 on the skirt portion outer peripheral surface 120. In the present embodiment, the base material 100 includes the streak 140 on the skirt portion outer peripheral surface 120. This configuration leads to an increase in a surface area of the base material 100 on the skirt portion outer peripheral surface 120, and thus an increase in a contact area between the base material 100 and the electrodeposited film 130, thereby improving the adhesion force therebetween. Therefore, the detachment of the electrodeposited film 130 from the base material 100 is prevented or reduced, so that the solid contact between the base material 100 and the cylinder 2 in the first range is further reliably prevented or reduced. Even if the electrodeposited film 130 is detached from the base material 100, this detachment leads to an exposure of the streak 140 formed on the base material 100 on the skirt portion outer peripheral surface 120, allowing the streak 140 to exert the lubrication function.

It is important to employ a less conductive material as the solid component (the coating material particles) in the electrodeposition coating material to improve the smoothness of the skirt portion outer peripheral surface 120 due to the electrodeposited film 130. More specifically, if a conductive solid component is added to the electrodeposition coating material, a conductive film is formed on the skirt portion outer peripheral surface 120 by the power supply. This film is less electrically resistive, thereby resulting in a reduction in the generation of the Joule heat. Therefore, the difference in the growth speed of the film due to the fusion of the coating material particles reduces between the bottom and the top of the streak 14. As a result, the formation of the even film thickness is facilitated, making it difficult for the film to be formed so as to fill the bottom of the streak 14 (the achievement of the smoothness is impeded). The above-described conductive solid component contains a conductive solid lubricant, such as graphite (hereinafter referred to as C) and molybdenum disulfide (hereinafter referred to as MoS₂). On the other hand, the electrodeposition coating material according to the present embodiment does not contain the conductive solid lubricant. Therefore, the electrodeposition coating material becomes further less conductive, which improves the above-described smoothing effect due to the electrodeposited film 130. It is allowable that a small amount of the conductive solid component (solid lubricant) is added or mixed in the electrodeposition coating material as long as the non-conductivity of the electrodeposition coating material is maintained to some degree and the above-described smoothing effect due to the electrodeposited film 130 can be acquired. Further, it is also allowable that the solid lubricant as the electric insulator (for example, PTFE) is contained in the electrodeposition coating material. In other words, even when the non-conductive solid lubricant is added to the electrodeposition coating material, the electrodeposition coating material when power is supplied exhibits a similar behavior to when the solid lubricant is not added at all, and the electrodeposited film 130 is formed so as to fill the bottom of the streak 14. The solid lubricant contained in the electrodeposited film 130 may be any material that is less conductive than C and MoS₂, and is not limited to PTFE.

Another film is not interposed between the base material 100 and the electrodeposited film 130. In the electrodeposition coating process, the base material 100 is exposed to the electrodeposition coating material on the skirt portion outer peripheral surface 120. Therefore, the skirt portion outer peripheral surface 120 can easily function as the electrode, and the electrodeposited film 130 can be easily formed.

### Second Embodiment

First, a configuration will be described. FIG. 10 illustrates a cross-section of the outer peripheral side of the skirt portion 12 in the plane containing the central axis O of the piston 1 according to the present embodiment. The film portion 13 includes the electrodeposited film 130 and also includes one film layer in addition to the electrodeposited film 130. More specifically, the skirt portion 12 of the piston 1 includes two film layers. The above-described film other than the electrodeposited film 130 is a lubrication film 131. The film portion 13 includes the electrodeposited film 130 and the lubrication film 131 in this order from one side where the base material 100 of the piston 1 is located. The electrodeposited film 130 covers the base material 100. The composition of the electrodeposited film 130 is similar to the first embodiment. The lubrication film 131 covers the electrodeposited film 130, and is exposed on the skirt portion outer peripheral surface 120. The lubrication film 131 contains a solid lubricant and a binder resin. The solid lubricant is C. The lubrication film 131 may contain, as the solid lubricant, another solid lubricant, such as at least one of MoS₂ and PTFE, together with or instead of C. The binder resin has a function of fixing the solid lubricant to a coating target object, and, for example, PAI is used as the binder resin. The lubrication film 131 may contain, as the binder resin, another binder resin, such as at least one of PI and EP, together with or instead of PAI. In the lubrication film 131, a contained amount of the solid lubricant is 50 wt % or more and 95 wt % or less, and a contained amount of the binder resin is 5 wt % or more and 50 wt % or less.

The method for processing the surface of the piston (the present processing) includes the process for forming the electrodeposited film and a process for forming the lubrication film. In the present processing, the process for forming the electrodeposited film and the process for forming the lubrication film are performed in this order. The procedure of the process for forming the electrodeposited film is similar to the first embodiment. The process for forming the lubrication film includes execution of a so-called drying and baking method that forms a dried film by applying a coating material in which the solid lubricant is distributed in a solution of the binder resin to a surface of a target object, and drying and baking that. In the process for forming the lubrication film, a coating process, a drying process, and a cooling process are performed in this order. Processing for, for example, removing oil and contamination from the skirt portion outer peripheral surface 120 (the electrodeposited film 130), which is the coating target, may be performed to, for example, improve adhesiveness of the lubrication film 131 before the coating process. In the coating process, the coating material is applied to the skirt portion outer peripheral surface 120 (the electrodeposited film 130) by screen printing. The coating material may be applied by printing other than screen printing, spraying the coating material with use of a spray or the like, or dipping the skirt portion outer peripheral surface 120 in the coating material. The coating material can be prepared by, for example, blending the binder resin and the solid lubricant in an organic solvent, adding an additive and hard particles to this solvent as necessary, and mixing and distributing it with use of a bead mill or the like. The coating material may be diluted with use of the organic solvent as necessary. The coated film covering the electrodeposited film 130 is formed on the skirt portion outer peripheral surface 120 by the coating process. In the drying process, the coated film is baked and dried under a drying condition such as heating it at 90 degrees Celsius to 120 degrees Celsius (a holding time is unnecessary). The drying process is ended when, for example, the coating material is dried enough not to stain a hand. A volatile component (the organic solvent) is removed from the above-described coated film by the drying, and along therewith, the solid lubricant is fixed on the skirt portion outer peripheral surface 120 via the binder resin by the baking, by which the lubrication film 131 is formed. In the cooling process, the skirt portion 12 (the lubrication film 131) after the burning process is cooled. The skirt portion 12 may be cooled naturally without being cooled forcibly.

The drying process in the process for forming the lubrication film may be changed to the burning process, and the burning process in the processing for forming the electrodeposited film may be changed to the drying process (similar to the drying process in the process for forming the lubrication film). There are four possible combinations as the process for forming the entire (multilayered) film depending on which is carried out for each of the films, the drying or the burning. However, it is preferable to carry out the burning at least once or more (burn at least one film) in the process for forming the entire film to improve strength of the film as a whole. Therefore, there are three possible combinations as the process for forming the entire film depending on which is carried out for each of the films, the drying or the burning, excluding a combination in which the burning is not carried out even once (the drying is carried out for all of the films). The present embodiment employs the combination in which the process for forming the electrodeposited film includes the burning process and the process for forming the lubrication film includes the drying process, as a representative process for forming the entire film, by way of example.

Next, functions and effects will be described. Due to the lubrication film 131, the friction reduces between the skirt portion outer peripheral surface 120 and the cylinder inner wall 20 at a relatively early (initial) stage after the operation of the engine is started. More specifically, even when the oil membrane is not formed between the skirt portion outer peripheral surface 120 and the cylinder inner wall 20 in the first range, since the lubrication film 131 is exposed on the skirt portion outer peripheral surface 120, the strength of the frictional force reduces therebetween due to the solid lubricant in the lubrication film 131. In the lubrication film 131, the contained amount of the solid lubricant may be 50 wt % or less (the contained amount of the binder resin is 50 wt % or more). In this case, the lubrication film 131 exerts a strong adhesion force, and excellent adhesiveness is achieved between the lubrication film 131 and the electrodeposited film 130. In the present embodiment, in the lubrication film 131, the contained amount of the solid lubricant is 50 wt % or more (the contained amount of the binder resin is 50 wt % or less). The lubrication film 131 is easily abraded by containing a large amount of the solid lubricant (a small amount of the binder resin). Therefore, the initial conformability when the outer peripheral surface of the piston 1 is slidably moved relative to the cylinder inner wall 20 is improved. More specifically, the first range (the surface of the lubrication film 131) is abraded and then smoothed early, and starts to conform to the cylinder inner wall 20 quickly. The smooth sliding surface is swiftly formed in the first range, and the lubrication gap exceeds the lower limit value. As a result, the lubrication in the first range is changed from the boundary lubrication to the fluid lubrication. Further, the improvement of the smoothness causes a reduction in the fluid lubrication frictional coefficient in the first range (and the second range as will be described below). These effects contribute to the reduction in the strength of the frictional force between the skirt portion outer peripheral surface 120 and the cylinder inner wall 20, and thus the reduction in the frictional loss on the skirt portion 12.

In the lubrication film 131, the contained amount of the binder resin is 5 wt % or more (the contained amount of the solid lubricant is 95 wt % or less). Therefore, the adhesion force of the lubrication film 131 is secured to some degree, and a reduction in the adhesiveness between the lubrication film 131 and the electrodeposited film 130 is prevented or cut down. The lubrication film 131 is not burned, and is more easily abraded than when being burned. Therefore, the initial conformability due to the lubrication film 131 can be easily acquired. A material having a low abrasion resistance property may be used as the binder resin contained in the lubrication film 131 to improve the initial conformability.

Due to the electrodeposited film 130, the streak shape on the base material 100 is smoothed (the streak 14 becomes shorter due to the electrodeposited film 130) at least in the second range of the skirt portion outer peripheral surface 120. The lubrication film 131 is formed so as to cover the smoothed skirt portion outer peripheral surface 120 (the electrodeposited film 130), by which the surface of the lubrication film 131 is also smoothed (consequently). In other words, the skirt portion outer peripheral surface 120 (at least the second range) covered by the lubrication film 131 is smoothed. As a result, the fluid lubrication frictional coefficient reduces in the second range. Conventionally, there has been known a piston including a film containing the solid lubricant and also having a high abrasion property on the skirt portion outer peripheral surface. In this piston, the film is abraded and starts conform to the inner wall of the cylinder early in the first range of the skirt portion outer peripheral surface, by which the lubrication therebetween is changed from the boundary lubrication to the fluid lubrication, and the fluid lubrication frictional coefficient reduces along therewith. However, in the second range other than the first range, the film is not moved while directly contacting the inner wall of the cylinder, so that the lubrication therebetween remains the fluid lubrication, and the height of the streak formed on the film in the second range is not changed along therewith. Therefore, the second range, which is the surface in contact with the oil, has low smoothness and exhibits a high friction. On the other hand, in the piston 1 according to the present embodiment, the streak 14 becomes shorter due to the electrodeposited film 130 in the second range, which is the surface in contact with the oil, so that the smoothness is improved. Therefore, not only in the first range but also in the second range, the friction reduces under the fluid lubrication. In other words, the frictional coefficient (the frictional force) reduces under the fluid lubrication throughout the entire skirt portion outer peripheral surface 120 (including the first range and the second range).

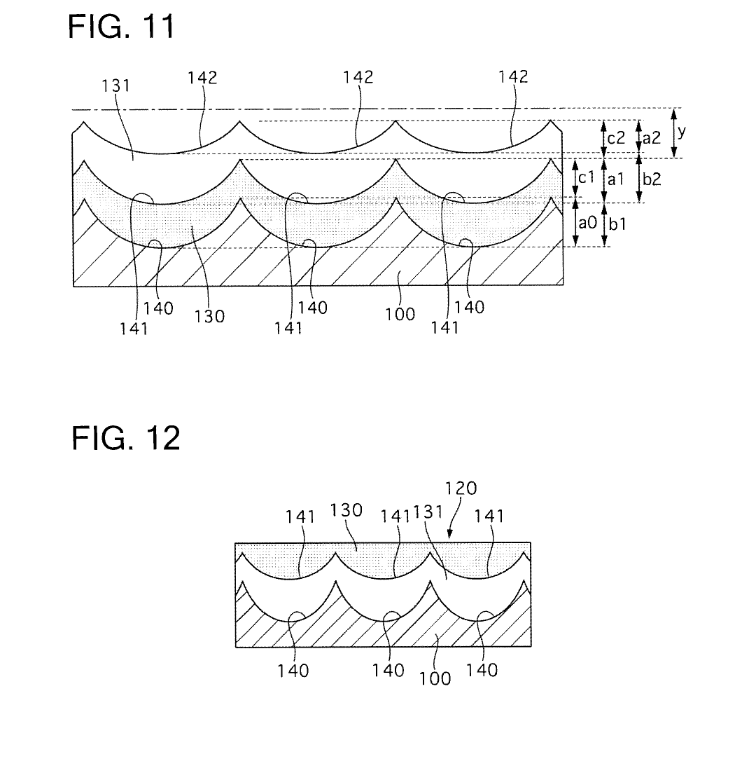

The meaning of the reduction in the height of the streak 14 due to the electrodeposited film 130 (the improvement of the smoothness) on the skirt portion outer peripheral surface 120 covered by the two films 130 and 131 can be understood in a similar manner to the first embodiment. This will be described now with reference to FIG. 11 illustrating a schematic cross-section similar to FIG. 9. In FIG. 11, a0, a1, b1, and c1 are similar to FIG. 9. A groove (a streak 142) is formed (consequently) on the surface of the lubrication film 131 covering the electrodeposited film 130 at the portion corresponding to the streak 141. Assume that a2 represents a height of the streak 142. Assume that b2 represents a distance from the lowermost portion of the streak 141 to a lowermost portion of the streak 142. Assume that c2 represents a distance from the uppermost portion (the top) of the streak 141 to an uppermost portion (a top) of the streak 142. The following equation (6) is established.

a2=a1+c2−b2 (Equation 6)

Hypnotically suppose that the surface of the lubrication film 131 after the coating process for forming the lubrication film 131 is performed and before the volatile component in the coating material is volatilized is a completely smooth surface without any dent and bump formed thereon as indicated by an alternate long and two short dashes line in FIG. 11. Assume that y represents a distance from the uppermost portion (the top) of the streak 141 to the surface of the lubrication film 131 before the above-described volatilization. The distance from the lowermost portion of the streak 141 to the surface of the lubrication film 131 before the above-described volatilization is (a1+y). Assume that β represents a ratio of a volume of the solid component to a volume of the entire coating material in the lubrication film 131. The solid component is the solid lubricant, the resin, or the like. The following equations (7) and (8) are established.

b2=(a1+y)β (Equation 7)

c2=β (Equation 8)

The ratio β ranges from 0.3 to 0.5 for the normal coating material, but ranges from 0.1 to 0.6 if also containing special types. The following equation (9) is established from the above-described equations (6) to (8).

a2=a1+βy−β(a1+y)=(1−β)a1 (Equation 9)

(1−β)a1 is the height of the streak 142 formed on the surface of the lubrication film 131 due to the volatilization of the volatile component of the coating material from the coating material of the lubrication film 131, based on a1. The above-described equation (9) is rewritten into the following equation (10) with use of the above-described equation (4).

a2=(1−α)(1−β)a0 (Equation 10)

In other words, by an amount corresponding to the volume ratios α and β of the solid components in the respective coating materials of the films 130 and 131, the streak 142 on the plurality of layers as these films 130 and 131 becomes shorter than the original streak 140. The reduction in the height of the streak 142 due to the electrodeposited film 130 (the improvement of the smoothness) means that a2 becomes shorter than (1−α)(1−β)a0, and therefore is expressed by the following equation (11).

a2<(1−α)(1−β)a0 (Equation 11)

This equation (11) is also derived from the above-described equations (5) and (9).

As indicated by the above-described equation (9), due to the volatilization of the volatile component of the coating material from the coating material of the film portion 13, the streak 14 is formed on the lubrication film 131 so as to have the height a2 that is obtained by the height a1 of the streak 141 on the electrodeposited film 130 being multiplied by the volume ratio (1−β) of the above-described volatile component. In other words, by the amount corresponding to the volume ratio β of the solid component in the coating material of the lubrication film 131, the streak 142 of the lubrication film 131 becomes shorter than the original streak 141. Comparing the above-described equations (5) and (11), the streak 142 becomes further shorter than the first embodiment (the streak 141) by an amount corresponding to β, due to the lubrication film 131. Therefore, the skirt portion outer peripheral surface 120 is more efficiently smoothed than when the electrodeposited film 130 is used alone.

The electrodeposited film 130 does not contain the solid lubricant while containing the binder resin. Therefore, the electrodeposited film 130 exerts a strong adhesion force, and the excellent adhesiveness is achieved between the electrodeposited film 130 and the base material 100. Further, excellent adhesiveness is achieved between the electrodeposited film 130 and the lubrication film 131. Further, the electrodeposited film 130 is cured by being burned. As a result, the detachment of the electrodeposited film 130 from the base material 100 is prevented or reduced. The electrodeposited film 130 may contain the solid lubricant that is the electric insulator similarly to the first embodiment. In this case, the present embodiment can acquire the smoothing effect due to the electrodeposited film 130 similarly to the first embodiment, and also acquire lubricity and the like due to the electrodeposited film 130 containing the solid lubricant when the electrodeposited film 130 is exposed on the skirt portion outer peripheral surface 120 due to, for example, the abrasion of the lubrication film 131.

### Third Embodiment

First, a configuration will be described. FIG. 12 illustrates a cross-section of the outer peripheral side of the skirt portion 12 in the plane containing the central axis O of the piston 1 according to the present embodiment. The skirt portion 12 includes two film layers similarly to the second embodiment. The films include the lubrication film 131 and the electrodeposited film 130 in this order from the base material 100 side. The lubrication film 131 covers the base material 100. The lubrication film 131 contains C as the solid lubricant. The solid lubricant may contain MoS₂ together with or instead of C. In the lubrication film 131, a contained amount of the solid lubricant is more than 0 wt % and 50 wt % or less, and a contained amount of the binder resin is 50 wt % or more and less than 100 wt %. The electrodeposited film 130 covers the lubrication film 131, and is exposed on the skirt portion outer peripheral surface 120. The composition of the electrodeposited film 130 is similar to the first embodiment.

In the method for processing the surface of the piston 1 (the present processing), the process for forming the lubrication film and the process for forming the electrodeposited film are performed in this order. In the process for forming the lubrication film, the coating process, the burning process, and the cooling process are performed in this order. In the burning process, the skirt portion 12 (the lubrication film 131) after the coating process is burned under burning conditions such as burning it at 180 degrees Celsius for 30 minutes and burning it at 200 degrees Celsius for 20 minutes. This process improves the hardness and the adhesiveness of the lubrication film 131 compared to the simple baking drying. The other processes in the process for forming the lubrication film are similar to the second embodiment. In the process for forming the electrodeposited film, the electrodeposition coating process, the water washing process, the drying process, and the cooling process are performed in this order. In the drying process, the coated film is baked and dried under a drying condition such as heating it at 90 degrees Celsius to 120 degrees Celsius (the holding time is unnecessary). The drying process is ended when, for example, the coating material is dried enough not to stain a hand. The other processes in the process for forming the electrodeposited film are similar to the first embodiment. The water washing process may be omitted.

Next, functions and effects will be described. Due to the electrodeposited film 130 and the lubrication film 131, the exposure of the base material 100 on the skirt portion outer peripheral surface 120 is prevented or reduced. Therefore, the scuff resistance property of the piston 1 is improved similarly to the first embodiment.

Due to the electrodeposited film 130, the smoothness of the skirt portion outer peripheral surface 120 is improved. As a result, the fluid lubrication frictional coefficient reduces at least in the second range. The electrodeposited film 130 does not contain the solid lubricant. Therefore, the electrodeposited film 130 exerts the strong adhesion force, and the excellent adhesiveness is achieved between the electrodeposited film 130 and the lubrication film 131. The electrodeposited film 130 may contain the solid lubricant that is the electric insulator similarly to the first embodiment. In this case, the present embodiment can acquire the smoothing effect due to the electrodeposited film 130 and also acquire the lubricity and the like due to the electrodeposited film 130. In the present embodiment, the electrodeposited film 130 does not contain the solid lubricant, and therefore has a higher abrasion resistance property than when containing the solid lubricant. On the other hand, the electrodeposited film 130 is not burned, and is more easily abraded than when being burned. Therefore, in the first range, the electrodeposited film 130 is abraded and then smoothed early, and easily starts to conform to the cylinder inner wall 20 quickly. Further, this makes it easy for the lubrication film 131 covered by the electrodeposited film 130 to be exposed on the skirt portion outer peripheral surface 120. As a result, the merits of the lubrication film 131 (the lubricity and the initial conformability) can be easily acquired. A material having a low abrasion resistance property may be used as the binder resin contained in the electrodeposited film 130 to allow the electrodeposited film 130 to be easily abraded. Further, in the case where the electrodeposited film 130 contains the solid lubricant that is the electric insulator, the contained amount of the solid lubricant may increase (in other words, the contained amount of the binder resin may reduce).

The lubrication film 131 contains the solid lubricant (the contained amount of the solid lubricant is more than 0 wt %). Therefore, when the lubrication film 131 is exposed on the skirt portion outer peripheral surface 120 due to, for example, the abrasion of the electrodeposited film 130 in the first range, the strength of the frictional force reduces between the skirt portion outer peripheral surface 120 and the cylinder inner wall 20 due to the solid lubricant similarly to the second embodiment. In the lubrication film 131, the contained amount of the solid lubricant may be 50 wt % or more. In this case, the lubrication film 131 is easily abraded. Therefore, when the lubrication film 131 is exposed on the skirt portion outer peripheral surface 120 due to, for example, the abrasion of the electrodeposited film 130 in the first range, the surface of the lubrication film 131 is abraded and then smoothed early, by which the initial conformability is improved, similarly to the second embodiment. In the present embodiment, in the lubrication film 131, the contained amount of the binder resin is 50 wt % or more (the contained amount of the solid lubricant is 50 wt % or less). Therefore, the lubrication film 131 exerts a high adhesion force, and excellent adhesiveness is achieved between the lubrication film 131 and the base material 100. Further, the excellent adhesiveness is achieved between the lubrication film 131 and the electrodeposited film 130. Further, the lubrication film 131 is cured by being burned. Therefore, the detachment of the lubrication film 131 from the base material 100 is prevented or reduced. The base material 100 includes the streak 140 on the skirt portion outer peripheral surface 120. Due to that, the lubrication film 131 further securely adheres to the base material 100. The solid lubricant contained in the lubrication film 131 is C or MoS₂, and is conductive. Therefore, in the electrodeposition coating process, the skirt portion outer peripheral surface 120 covered by the lubrication film 131 easily functions as the electrode, and the electrodeposited film 130 is easily formed on the lubrication film 131.

FIG. 13 illustrates a cross-section of the outer peripheral side of the skirt portion 12 in the plane containing the central axis O of the piston 1 in a result of an experiment when the electrodeposition conditions in the electrodeposition coating process were set to 60 V and 5 seconds. A table 1 indicates the film thickness of each of the films and the height of the streak 14 formed in this experiment.

TABLE 1

| | Height of Streak | Film Thickness |
|---|---|---|
| Layer | (μm) | (μm) |
| Electrodeposition Film | 1.7 | 2.0 |
| Lubrication Film | 6.5 | 6.9 |
| Base Material of Piston | 9.5 | — |

Now, the film thickness refers to the distance from the uppermost portion (the top) of the streak 14 on the film on some layer to the uppermost portion (the top) of the streak 14 on the film on a next layer covering the film on some layer in the normal direction of the skirt portion outer peripheral surface 120. A reference position for measuring the film thickness is not limited to the top of the streak 14. Each of numerical values indicating the film thicknesses and the height of the streak 14 indicates an average for a plurality of streaks 14. The height a0 of the streak 140 processed on the base material 100 was 9.5 μm. The film thickness of the lubrication film 131 was 6.9 μm. The height a1 of the streak 141 formed on the lubrication film 131 was 6.5 μm. The film thickness of the electrodeposited film 130 was 2.0 μm. The height a2 of the streak 142 formed on the electrodeposited film 130 was 1.7 μm. The meaning of the reduction in the height of the streak 14 due to the electrodeposited film 130 (the improvement of the smoothness) can be understood in a similar manner to the second embodiment. The height a1 (=6.5 μm) corresponds to “the height of the streak 141 formed due to the volatilization of the volatile component of the coating material from the coating material of the lubrication film 131 based on the height a0 of the streak 140, (1−β)a0.” The height a2 (=1.7 μm) corresponds to a height shorter than “the height of the streak 142 formed due to the volatilization of the volatile component of the electrodeposition coating material from the electrodeposition coating material based on the height a1 of the streak 141, (1−α)a1=(1−α)(1−β)a0.”

According to the graph (the straight line L) illustrated in FIG. 8, the fluid lubrication frictional coefficient is approximately 0.012, approximately 0.009, and approximately 0.004 when the height of the streak 14 on the skirt portion outer peripheral surface 120 is a0 (=9.5 μm), a1 (=6.5 μm), and a2 (=1.7 μm), respectively. Therefore, it can be understood that, in the piston 1 according to the present embodiment, the fluid lubrication frictional coefficient reduces to approximately one-third due to the reduction in the height of the streak 14 from a0 to a2, compared to a piston in which the streak 140 of the base material 100 is exposed on the skirt portion outer peripheral surface 120 (hereinafter referred to as a comparative example 1). Further, it can be understood that the fluid lubrication frictional coefficient reduces to approximately four-ninths due to the reduction in the height of the streak 14 from a1 to a2, compared to a piston in which the skirt portion outer peripheral surface 120 (the base material 100) is covered by only the lubrication film 131 (hereinafter referred to as a comparative example 2). According to the graph illustrated in FIG. 8, the fluid lubrication frictional coefficient is approximately 0.0045 or lower when the height of the streak 14 on the skirt portion outer peripheral surface 120 is 2.0 μm or shorter. It can be understood that, at this time, the fluid lubrication frictional coefficient reduces to approximately three-eighths or lower compared to the comparative example 1 and reduces to approximately half or lower compared to the comparative example 2.

A table 2 indicates an experiment result indicating the height a2 of the streak 142 when the electrodeposition conditions were changed. The heights a0 and a1 of the streaks 140 and 141 and the film thickness of the lubrication film 131 were the same as the experiment result when the electrodeposition conditions were set to 60 V and 5 seconds.

TABLE 2

Processing Time (sec)

| | | 5 | 10 | 15 | 30 |
|---|---|---|---|---|---|
| voltage (V) | 40 | 5.0 | 6.3 | 1.1 | 1.3 |
| | 60 | 1.7 | 1.6 | 1.0 | 0.9 |
| | 80 | — | 1.5 | — | — |
| | 100 | — | 1.5 | — | — |

With the processing time (the power supply time) set to 5 seconds, a2 was 5.0 μm and 1.7 μm when the voltage was 40 V and 60 V, respectively. With the processing time set to 10 seconds, a2 was 6.3 μm, 1.6 μm, and 1.5 μm when the voltage was 40 V, 60 V, and 80 V and 100 V, respectively. Under such conditions that a0 and a1 were 7.5 μm and 5.3 μm, respectively, with the processing time set to 15 seconds, a2 was 1.1 μm and 1.0 μm when the voltage was 40 V and 60 V, respectively. Under the same conditions, with the processing time set to 30 seconds, a2 was 1.3 μm and 0.9 μm when the voltage was 40 V and 60 V, respectively. When the voltage was 40 V, a2 did not reduce so much from the height of the streak 141 with the processing time set to 10 seconds or shorter. When the voltage was 60 V, a2 reduced significantly from the height of the streak 141 to reach or fall below 2.0 μm even with the processing time set to 10 seconds or shorter. In this manner, even when the voltage increased to higher than 60 V, a2 did not change so much with the processing time set to 10 seconds. When the voltage was 60 V, even with the processing time set to 5 seconds, a2 did not change so much from the value when the processing time was set to 10 seconds. Therefore, it can be understood that the electrodeposition at 60 V for 5 seconds was enough as the electrodeposition conditions for keeping the voltage low, shortening the processing time, and reducing a2 to 2.0 μm or shorter. The lubrication film 131 was interposed between the base material 100 and the electrodeposited film 130. The electrodeposition was carried out by the flow of the current through the lubrication film 131 and the precipitation of the electrodeposition coating material on the surface of the lubrication film 131. The lubrication film 131 was less conductive than the base material 100, and the base material 100 was covered by the film thickness of 6.9 μm. It can be understood that, even in this case, the electrodeposited film 130 including the streak 142 having the height a2 as short as 2.0 μm or shorter was formed under the electrodeposition conditions of 60V and 5 seconds as described above.

When the electrodeposition conditions were set to 60 V and 5 seconds, the film thickness of the electrodeposited film 130 was 2.0 μm. This value is considerably smaller than the film thickness of the lubrication film 131 (6. 9 μm). The increase in the film thickness of the electrodeposited film 130 is prevented or cut down in this manner, which makes it easy for the electrodeposited film 130 to be abraded. As a result, the initial conformability and the lubricity are improved as described above. To improve the initial conformability and the like, the film thickness of the electrodeposited film 130 is not limited to 2.0 μm, and may be, for example, slightly thicker than approximately 3.0 μm and is preferably 3 μm or thinner (thicker than 0 μm).

### Fourth Embodiment

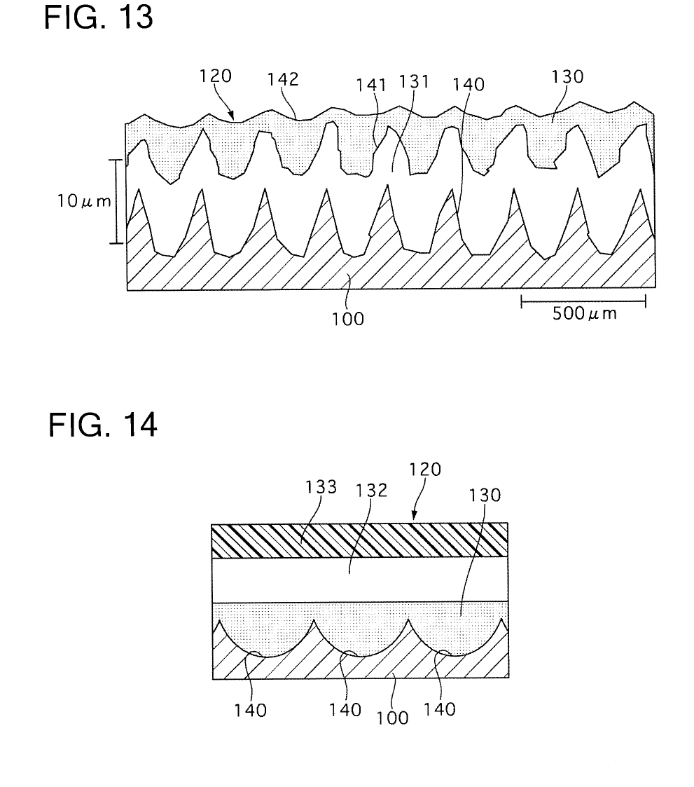

First, a configuration will be described. FIG. 14 illustrates a cross-section of the outer peripheral side of the skirt portion 12 in the plan containing the central axis O of the piston 1 according to the present embodiment. The film portion 13 includes the electrodeposited film 130, and also includes a lower layer film (a first film) 132 and an upper layer film (a second film) 133 in addition to the electrodeposited film 130. In other words, the skirt portion 12 of the piston 1 includes three film layers. The lower layer film 132 and the upper layer film 133 correspond to the lubrication film containing the binder resin and the solid lubricant that is multilayered. The film portion 13 includes the electrodeposited film 130, the lower layer film 132, and the upper layer film 133 in this order from the base material 100 side. The electrodeposited film 130 covers the base material 100. The composition of the electrodeposited film 130 is similar to the first embodiment. The lower layer film 132 is located on one side closer to the base material 100 than the upper layer film 133 is, i.e., a lower layer side, and covers the electrodeposited film 130. The lower layer film 132 contains PAI as the binder resin. The binder resin may contain at least one of PI and EP together with or instead of PAI. The lower layer film 132 contains C as the solid lubricant. The solid lubricant may contain at least one of MoS₂ and PTFE together with or instead of C. In the lower layer film 132, a contained amount of the solid lubricant is more than 0 wt % and 50 wt % or less, and a contained amount of the binder resin is 50 wt % or more and less than 100 wt %. The upper layer film 133 is located on another side farther away from the base material 100 than the lower layer film 132 is, i.e., an upper layer side. The upper layer film 133 covers the lower layer film 132, and is exposed on the skirt portion outer peripheral surface 120. The upper layer film 133 contains PAI as the binder resin. The binder resin may contain at least one of PI and EP together with or instead of PAI. The upper layer film 133 contains MoS₂ as the solid lubricant. The solid lubrication may contain at least one of C and PTFE together with or instead of MoS₂. In the upper layer film 133, a contained amount of the solid lubricant is 50 wt % or more and 95 wt % or less, and a contained amount of the binder resin is 5 wt % or more and 50 wt % or less.

The method for processing the surface of the piston 1 (the present processing) includes the process for forming the electrodeposited film, a process for forming the lower layer film, and a process for forming the upper layer film. In the present processing, the process for forming the electrodeposited film, the process for forming the lower layer film, and the process for forming the upper layer film are performed in this order. A procedure of the process for forming the electrodeposited film is similar to the first embodiment. Procedures of the process for forming the lower layer film and the process for forming the upper layer film are similar to the procedure of the process for forming the lubrication film according to the second embodiment. The burning process in the process for forming the electrodeposited film may be changed to the drying process. The drying process in the process for forming the lower layer film may be chanted to the burning process, and the drying process in the process for forming the upper layer film may be changed to the burning process. There are eight possible combinations as the process for forming the entire film depending on which is performed for each of the films, the drying or the burning. There are seven possible combinations as the process for forming the entire film, excluding a combination in which the burning is not carried out even once (the drying is carried out for all of the films). The present embodiment employs the combination in which the process for forming the electrodeposited film includes the burning process and the process for forming the lower layer film and the process for forming the upper layer film include the drying process, as a representative process for forming the entire film, by way of example.

Next, functions and effects will be described. The film portion 13 includes the lower layer film 132 and the upper layer film 133 in this order. Due to the upper layer film 133, the present embodiment can acquire similar functions and effects to the lubrication film according to the second embodiment (the initial conformability and the like). The lower layer film 132 includes the solid lubricant (the contained amount of the solid lubricant is more than 0 wt %). Therefore, when the lower layer film 132 is exposed on the skirt portion outer peripheral surface 120 due to, for example, abrasion of the upper layer film 133, in the first range, the strength of the frictional force reduces between the skirt portion outer peripheral surface 120 and the cylinder inner wall 20 due to the solid lubricant in the lower layer film 132 similarly to the second embodiment. In the lower layer film 132, the contained amount of the binder resin is 50 wt % or more (the contained amount of the solid lubricant is 50 wt % or less). Therefore, the lower layer film 132 exerts a strong adhesion force, and excellent adhesiveness is achieved between the lower layer film 132 and the electrodeposited film 130. Further, excellent adhesiveness is achieved between the lower layer film 132 and the upper layer film 133.

Due to the electrodeposited film 130, the present embodiment can acquire similar functions and effects to the electrodeposited film 130 according to the second embodiment (the improvement of the smoothness and the like). More specifically, the skirt portion outer peripheral surface 120 covered by the lubrication film (the upper layer film 133) is smoothed. The meaning of the reduction in the height of the steak 14 on the skirt portion outer peripheral surface 120 covered by the three film layers due to the electrodeposited film 130 (the improvement of the smoothness) can be understood in a similar manner to the first and second embodiments. For example, this can be confirmed by making a similar calculation to the second embodiment, assuming that β represents a ratio of a volume of the solid component to a volume of the entire coating material in the lower layer film 132, and γ represents a ratio of a volume of the solid component to a volume of the entire coating material in the upper layer film 133. The skirt portion outer peripheral surface 120 is further efficiently smoothed by forming the plurality of (two) films 132 and 133 in addition to the electrodeposited film 130. The electrodeposited film 130 may contain the solid lubricant that is the electric insulator, similarly to the second embodiment.

### Fifth Embodiment

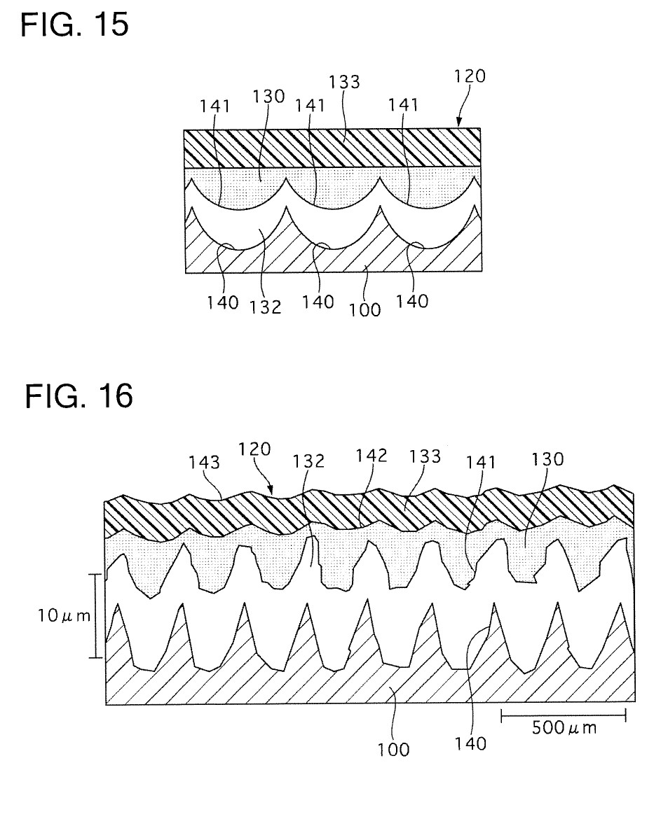

First, a configuration will be described. FIG. 15 illustrates a cross-section of the outer peripheral side of the skirt portion 12 in the plane containing the central axis O of the piston 1 according to the present embodiment. The skirt portion 12 includes three film layers similarly to the fourth embodiment. The film portion 13 includes the lower layer film 132, the electrodeposited film 130, and the upper layer film 133 in this order from the base material 100 side. The lower layer film 132 covers the base material 100. The composition of the lower layer film 132 is similar to the lubrication film 131 according to the third embodiment. The electrodeposited film 130 covers the lower layer film 132. The composition of the electrodeposited film 130 is similar to the first embodiment. The upper layer film 133 covers the electrodeposited film 130, and is exposed on the skirt portion outer peripheral surface 120. The composition of the upper layer film 133 is similar to the fourth embodiment. In the method for processing the surface of the piston 1 (the present processing), the process for forming the lower layer film, the process for forming the electrodeposited film, and the process for forming the upper layer film are performed in this order. The procedure of the process for forming the lower layer film is similar to the procedure of the process for forming the lubrication film according to the third embodiment. The procedure of the process for forming the electrodeposited film is similar to the third embodiment. The procedure of the process for forming the upper layer film is similar to the fourth embodiment.

Next, functions and effects will be described. Due to the upper layer film 133, the present embodiment can acquire similar functions and effects to the lubrication film 131 according to the second embodiment (the initial conformability and the like). Due to the electrodeposited film 130, the skirt portion outer peripheral surface 120 (at least the second range) covered by the lubrication film (the upper layer film 133) is smoothed similarly to the electrodeposited film 130 according to the second embodiment. The electrodeposited film 130 does not contain the solid lubricant. Therefore, the electrodeposited film 130 exerts a strong adhesion force, and excellent adhesiveness is achieved between the electrodeposited film 130 and the lower layer film 132. Further, excellent adhesiveness is achieved between the electrodeposited film 130 and the upper layer film 133. The electrodeposited film 130 may contain the solid lubricant that is the electric insulator, similarly to the second embodiment. The electrodeposited film 130 is not burned, and therefore is abraded and then smoothed early (together with the upper layer film 133) in the first range, thereby easily starting to conform to the cylinder inner wall 20 quickly, similarly to the electrodeposited film 130 according to the third embodiment. Further, this makes it easy for the lower layer film 132 covered by the electrodeposited film 130 to be exposed on the skirt portion outer peripheral surface 120, so that the merits (the lubricity and the initial conformability) of the lower layer film 132 can be easily acquired. The electrodeposited film 130 may contain the binder resin having a low abrasion resistance property or may contain a large amount of the solid lubrication that is the electric insulator, similarly to the third embodiment. Due to the lower layer film 132, the present embodiment can acquire similar functions and effects to the lubrication film 131 according to the third embodiment.

FIG. 16 illustrates a similar cross-section to FIG. 13 in a result of an experiment when the electrodeposition conditions were set to 60 V and 5 seconds. A table 3 indicates the film thickness of each of the films and the height of the streak 14 formed in this experiment. The heights a0, a1, and a2 of the streaks 140, 141, and 142, and the film thicknesses of the lower layer film 132 and the electrodeposited film 130 were the same as the result of the experiment according to the third embodiment (FIG. 13 and the table 1).

TABLE 3

| | Height of Streak | Film Thickness |
|---|---|---|
| Layer | (μm) | (μm) |
| Upper Layer Film | 1.2 | 4.0 |
| Electrodeposition Film | 1.7 | 2.0 |
| Lower Layer Film | 6.5 | 6.9 |
| Base Material of Piston | 9.5 | — |

The film thickness of the upper layer film 133 was 4.0 μm. The height a3 of the streak 143 formed on the upper layer film 133 was 1.2 μm. The height a3 corresponds to “the height of the streak 143 formed due to the volatilization of the volatile component of the coating material from the coating material of the upper layer film 133 based on the height a2 of the streak 142, (1−γ)a2.” It can be understood that the height a3 of the streak 143 on the skirt portion outer peripheral surface 120 was shorter than the third embodiment (the height a2 of the streak 142=1.7 μm) by an amount corresponding to being covered by the upper layer film 133.

According to the graph (the straight line L) indicated by the graph illustrated in FIG. 8, the fluid lubrication frictional coefficient is approximately 0.0037 when the height of the streak 14 on the skirt portion outer peripheral surface 120 is a3 (=1.2 μm). Therefore, it can be understood that, in the piston 1 according to the present embodiment, the fluid lubrication frictional coefficient reduces to approximately 30% compared to the above-described comparative example 1 due to the reduction in the height of the streak 14 from a0 to a3. Further, it can be understood that the fluid lubrication frictional coefficient reduces to approximately 40% compared to the above-described comparative example 2 due to the reduction in the height of the streak 14 from a1 to a3.

The film thickness of the electrodeposited film 130 was 3 μm or shorter. The increase in the film thickness of the electrodeposited film 130 is prevented or cut down in this manner, which makes it easy for the electrodeposited film 130 to be abraded. As a result, the initial conformability and the lubricity are improved as described above. The film thickness of the electrodeposited film 130 may be, for example, slightly thicker than approximately 3.0 μm to improve the initial conformability and the like.

### Sixth Embodiment

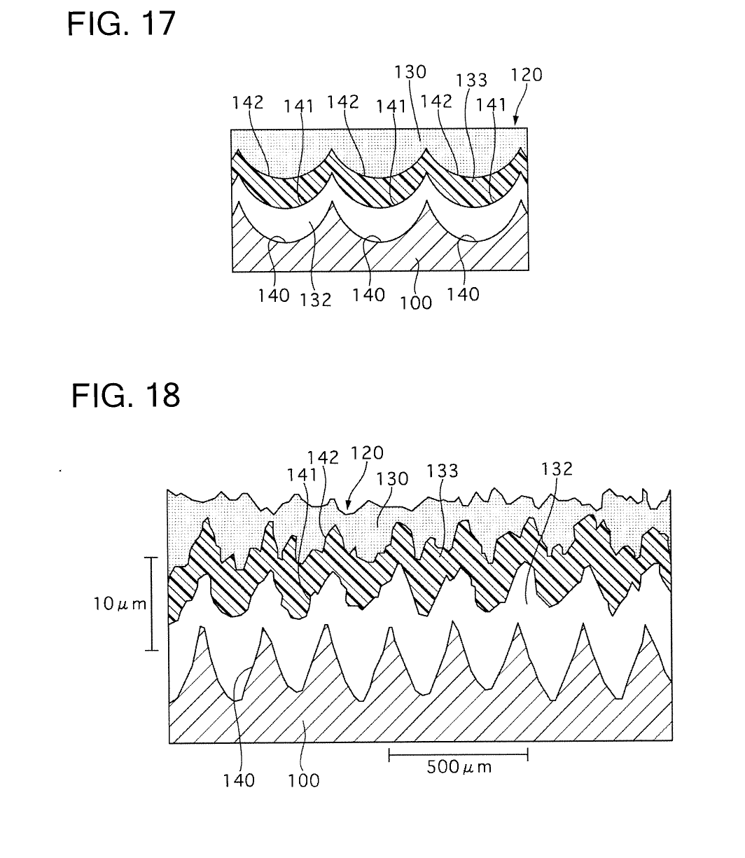

First, a configuration will be described. FIG. 17 illustrates a cross-section of the outer peripheral side of the skirt portion 12 in the plane containing the central axis O of the piston 1 according to the present embodiment. The skirt portion 12 includes three film layers similarly to the fourth embodiment. The film portion 13 includes the lower layer film 132, the upper layer film 133, and the electrodeposited film 130 in this order from the base material 100 side. The lower layer film 132 covers the base material 100. The composition of the lower layer film 132 is similar to the lubrication film 131 according to the third embodiment. The upper layer film 133 covers the lower layer film 132. The composition of the upper layer film 133 is similar to the fourth embodiment. The upper layer film 133 contains MoS₂ as the solid lubricant. The solid lubricant may contain C together with or instead of MoS₂ but does not contain PTFE. The electrodeposited film 130 covers the upper layer film 133, and is exposed on the skirt portion outer peripheral surface 120. The composition of the electrodeposited film 130 is similar to the first embodiment. In the method for processing the surface of the piston 1 (the present processing), the process for forming the lower layer film, the process for forming the upper layer film, and the process for forming the electrodeposited film are performed in this order. The procedure of the process for forming the lower layer film and the procedure of the process for forming the upper layer film are similar to the procedure of the process for forming the lubrication film according to the third embodiment. For example, after the burning process in the process for forming the lower layer film, the coating process in the process for forming the upper layer film is performed when the temperature of the piston 1 is 50 degrees Celsius to 120 degrees Celsius. The procedure of the process for forming the electrodeposited film is similar to the third embodiment.

Next, functions and effects will be described. Due to the electrodeposited film 130, the present embodiment can acquire similar functions and effects to the electrodeposited film 130 according to the third embodiment (the smoothness of the outer peripheral surface 120 and the like). When the upper layer film 133 is exposed on the skirt portion outer peripheral surface 120 due to, for example, abrasion of the electrodeposited film 130 in the first range, the strength of the frictional force reduces due to the solid lubricant in the upper layer film 133 and the upper layer film 133 is abraded early along therewith, by which the initial conformability is improved. When the lower layer film 132 is exposed on the skirt portion outer peripheral surface 120 due to, for example, the abrasion of the electrodeposited film 130 and the upper layer film 133 in the first range, the strength of the frictional force reduces due to the solid lubricant in the lower layer film 132.

In the lower layer film 132, the contained amount of the binder resin is 50 wt % or more (the contained amount of the solid lubricant is 50 wt % or less). Therefore, the lower layer film 132 exerts a strong adhesion force, and excellent adhesiveness is achieved between the lower layer film 132 and the base material 100. Further, excellent adhesiveness is achieved between the lower layer film 132 and the upper layer film 133. The solid lubricants contained in the lower layer film 132 and the upper layer film 133 are C or MoS₂, and are conductive. Therefore, in the electrodeposition coating process, the skirt portion outer peripheral surface 120 covered by the lower layer film 132 and the upper layer film 133 can easily function as the electrode, and the electrodeposited film 130 can be easily formed on the upper layer film 133.

FIG. 18 illustrates a similar cross-section to FIG. 13 in a result of an experiment when the electrodeposition conditions were set to 100 V and 10 seconds. A table 4 indicates the film thickness of each of the films and the height of the streak 14 formed in this experiment.

TABLE 4

| | Height of Streak | Film Thickness |
|---|---|---|
| Layer | (μm) | (μm) |
| Electrodeposition Film | 1.9 | 3.2 |
| Upper Layer Film | 5.2 | 4.0 |
| Lower Layer Film | 5.6 | 6.0 |
| Base Material of Piston | 8.8 | — |

The height a0 of the streak 140 was 8.8 μm. The film thickness of the lower layer film 132 was 6.0 μm. The height a1 of the streak 141 formed on the lower layer film 132 was 5.6 μm. The film thickness of the upper layer film 133 was 4.0 μm. The height a2 of the streak 142 formed on the upper layer film 133 was 5.2 μm. The film thickness of the electrodeposited film 130 was 3.2 μm. The height a3 of the streak 143 formed on the electrodeposited film 130 was 1.9 μm. The height a1 (=5.6 μm) corresponds to “the height of the streak 141 formed due to the volatilization of the volatile component of the coating material from the coating material of the lower layer film 132 based on the height a0 of the streak 140, (1−β)a0.” The height a2 (=5.2 μm) corresponds to “the height of the streak 142 formed due to the volatilization of the volatile component of the coating material from the coating material of the upper layer film 133 based on the height a1 of the streak 141, (1−γ)a1=(1−β)(1−γ)a0.”

The height a3 (=1.9 μm) corresponds to a shorter height than “the height of the streak 143 formed due to the volatilization of the volatile component of the electrodeposition coating material from the electrodeposition coating material based on the height a2 of the streak 142, (1−α)a2=(1−α)(1−β)(1−γ)a0.”

According to the graph (the straight line L) indicated by the graph illustrated in FIG. 8, the fluid lubrication frictional coefficient is approximately 0.011, 0.008, and approximately 0.004 when the height of the streak 14 on the skirt portion outer peripheral surface 120 is a0 (=8.8 μm), a2 (=5.2 μm), and a3 (=1.9 μm), respectively. Therefore, it can be understood that, in the piston 1 according to the present embodiment, the fluid lubrication frictional coefficient reduces to approximately 40% compared to the above-described comparative example 1 due to the reduction in the height of the streak 14 from a0 to a3. Further, it can be understood that the fluid lubrication frictional coefficient reduces to approximately half compared to the example in which the skirt portion outer peripheral surface 120 (the base material 100) is covered by only the lubrication films 132 and 133 due to the reduction in the height of the streak 14 from a2 to a3.

A table 5 indicates an experiment result indicating the height a3 of the streak 143 when the electrodeposition conditions were changed. The heights a0 to a2 of the streaks 140 to 142 and the film thicknesses of the lubrication films 132 and 133 were the same as the above-described experiment result when the electrodeposition conditions were set to 100 V and 10 seconds.

TABLE 5

Processing Time (sec)

| | | 5 | 10 |
|---|---|---|---|
| voltage (V) | 60 | 5.0 | 4.4 |
| | 80 | 4.4 | 3.9 |
| | 100 | 3.4 | 1.9 |
| | 120 | 3.8 | 5.0 |

With the processing time set to 5 seconds, a3 was 5.0 μm, 4.4 μm, 3.4 μm, and 3.8 μm when the voltage was 60 V, 80 V, 100 V, and 120 V, respectively. With the processing time set to 10 seconds, a3 was 4.4 μm, 3.9 μm, 1.9 μm, and 5.0 μm when the voltage was 60 V, 80 V, 100 V, and 120 V, respectively. In this manner, when the voltage was 100 V or lower, a3 reduced as the voltage increased regardless of the processing time. When the voltage was 120 V, a3 was taller than when the voltage was 100 V regardless of the processing time. When the voltage was 100 V or lower, a3 was shorter when the processing time was 10 seconds than when the processing time was 5 seconds. Under 60 V and 5 seconds, a3 was 5.0 μm, and hardly reduced from a2 (=5.2 μm). It can be understood that the generation of the electrodeposited film to reduce a3 was insufficient under 60 V and 5 seconds. It can be understood that a3 was able to reduce to 2.0 μm or shorter under 100 V and 10 seconds. The lubrication films (the lower layer film 132 and the upper layer film 133) were interposed between the base material 100 and the electrodeposited film 130. The electrodeposition was carried out by the flow of the current through the lubrication films 132 and 133 and the precipitation of the electrodeposition coating material on the surface of the upper layer film 133. The lubrication films 132 and 133 were less conductive than the base material 100, and the base material 100 was covered by a film thickness of 10.0 μm (=6.0 μm+4.0 μm). It can be understood that, even in this case, the electrodeposition film 130 including the streak 143 having the height a3 as short as 2.0 μm or shorter was formed under the electrodeposition conditions of 100V and 10 seconds as described above.

When the electrodeposition conditions were set to 100 V and 10 seconds, the film thickness of the formed electrodeposited film 130 was 3.2 μm. This value is considerably smaller than the film thicknesses of the lubrication films 132 and 133 (10. 0 μm). In this manner, the increase in the film thickness of the electrodeposited film 130 is prevented or cut down, which makes it easy for the electrodeposited film 130 to be abraded. As a result, the initial conformability and the lubricity are improved as described above. The electrodeposited film 130 may contain the binder resin having a low abrasion resistance property or may contain a large amount of the solid lubrication that is the electric insulator, similarly to the third embodiment.

### Other Embodiments

Having described embodiments for implementing the present invention based on the exemplary embodiments thereof, the specific configuration of the present invention is not limited to the exemplary embodiments, and the present invention also includes a design modification and the like thereof made within a range that does not depart from the spirit of the present invention. For example, the base material of the piston is not limited to aluminum alloy and may be iron or the like. PAI, PI, and EP can be applied to not only the base material but also another material because they can achieve excellent adhesiveness. Further, the individual components described in the claims and the specification can be arbitrarily combined or omitted within a range that allows them to remain capable of achieving at least a part of the above-described objects or producing at least a part of the above-described advantageous effects.

The present application claims priority to Japanese Patent Application No. 2015-059906 filed on Mar. 23, 2015. The entire disclosure of Japanese Patent Application No. 2015-059906 filed on Mar. 23, 2015 including the specification, the claims, the drawings, and the abstract is incorporated herein by reference in its entirety.

### REFERENCE SIGN LIST

1 piston
100 base material
12 skirt portion
120 outer peripheral surface
13 film
130 electrodeposited film
132 lower layer film (first film)
133 upper layer film (second film)
14 streak
2 cylinder
20 inner wall

1. A piston of an internal combustion engine, the piston comprising:
an electrodeposited film provided on an outer peripheral side of a skirt portion that faces an inner wall of a cylinder.

2. The piston of the internal combustion engine according to claim 1, wherein a base material of the piston includes a streak on the outer peripheral side of the skirt portion.

3. The piston of the internal combustion engine according to claim 2, further comprising a first film and a second film in addition to the electrodeposited film,
wherein the first film and the second film are disposed in an order of the first film and the second film as viewed from one side where the base material of the piston is located,
wherein the first film and the second film each contain a binder resin,
wherein a contained amount of a solid lubricant in the first film is 50% by weight or less, and
wherein a contained amount of a solid lubricant in the second film is 50% by weight or more and 95% by weight or less.

4. The piston of the internal combustion engine according to claim 3, wherein the first film, the second film, and the electrodeposited film are disposed in an order of the first film, the electrodeposited film, and the second film as viewed from the one side where the base material of the piston is located.

5. The piston of the internal combustion engine according to claim 4, wherein the electrodeposited film does not contain the solid lubricant or contains an electrically insulating solid lubricant.

6. The piston of the internal combustion engine according to claim 3, wherein the first film, the second film, and the electrodeposited film are disposed in an order of the first film, the second film, and the electrodeposited film as viewed from the one side where the base material of the piston is located.

7. The piston of the internal combustion engine according to claim 2, further comprising a film in addition to the electrodeposited film,
wherein the film contains a binder resin, and
wherein a contained amount of a solid lubricant is 50% by weight or less.

8. A piston of an internal combustion engine, the piston comprising:
a film provided on an outer peripheral side of a skirt portion that faces an inner wall of a cylinder and formed by electrodepositing a coating material.

9. A method for processing a surface of a piston of an internal combustion engine, the method comprising:
forming a film on an outer peripheral side of a skirt portion that faces an inner wall of a cylinder by electrodepositing a coating material.

10. The method for processing the surface of the piston of the internal combustion engine according to claim 9, further comprising ending the processing of the surface without burning the film formed by the electrodeposition.

11. The method for processing the surface of the piston of the internal combustion engine according to claim 10, wherein the coating material does not contain a solid lubricant or contains an electrically insulating solid lubricant.
